(19) United States
(12) Patent Application Publication
(10) Pub. No.: US 2026/0111704 A1
(43) Pub. Date: Apr. 23, 2026

(54) DECISION TRANSFORMER FRAMEWORK FOR ONLINE SYSTEMS

(71) Applicant: Microsoft Technology Licensing, LLC, Redmond, WA (US)

(72) Inventors: Sirou Zhu, Sunnyvale, CA (US); Neil Miten Daftary, Sunnyvale, CA (US); Ye Tao, Piscataway, NJ (US)

(73) Assignee: Microsoft Technology Licensing, LLC, Redmond, WA (US)

(21) Appl. No.: 18/918,316

(22) Filed: Oct. 17, 2024

(51) Int. Cl. G06N 3/045

(52) U.S. Cl. CPC G06N 3/045

(57) ABSTRACT

Artificial intelligence (AI) techniques for connection networking are described. A method comprises receiving a first vector by an embedding layer of a decision transformer, the first vector comprising entity trajectory features associated with an entity identifier of a connection network system, generating a first entity trajectory embedding from the set of entity trajectory features by the embedding layer, the first entity trajectory embedding comprising a sequence of values representing a first state, a first action, and a first reward associated with a first timestep, generating a predicted action embedding based on the first entity trajectory embedding by the decision transformer, the predicted action embedding comprising values representing a predicted action to achieve a total reward given the first state, the first action, and the first reward, selecting a target content item based on the predicted action embedding, and causing presentation of the target content item on a user interface.

### BACKGROUND

A social networking system is an online platform where connections can create profiles, connect with friends, family, and colleagues, and share various types of content such as photos, videos, and status updates. These platforms often offer features like messaging, groups, events, and news feed to keep connections engaged and connected, connection network systems facilitate communication, networking, and content sharing among connections, creating a digital community where people can interact and engage with others in their social circle or with like-minded individuals. Similarly, a connection network system allows individuals to connect with colleagues, potential employers, and other professionals in their industry. It is geared towards professional networking, job searching, and recruiting. Professionals can create a profile showcasing their work experience, skills, and education, as well as connect with others in their field. Connection network systems also provide a platform for sharing content, participating in discussions, and accessing industry news and insights.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a system in accordance with one embodiment.

FIG. 3 illustrates a content delivery system in accordance with one embodiment.

FIG. 4 illustrates a logic diagram in accordance with one embodiment.

FIG. 5 illustrates machine learning (ML) architecture in accordance with one embodiment.

FIG. 6 illustrates an ML architecture in accordance with one embodiment.

FIG. 7 illustrates an ML architecture in accordance with one embodiment.

FIG. 8 illustrates a transformer model in accordance with one embodiment.

FIG. 9 illustrates an apparatus in accordance with one embodiment.

FIG. 10 illustrates a logic flow in accordance with one embodiment.

FIG. 11 illustrates a logic flow in accordance with one embodiment.

FIG. 12 illustrates a logic diagram in accordance with one embodiment.

FIG. 13 illustrates an artificial neural network (ANN) in accordance with one embodiment.

FIG. 14 illustrates a computer-readable storage medium in accordance with one embodiment.

FIG. 15 illustrates a computing architecture in accordance with one embodiment.

FIG. 16 illustrates a communications architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. Although exemplary embodiments are described in connection with a particular AI system or an ML model, the principles described herein can also be applied to other types of AI systems and ML models as well. Embodiments are not limited in this context.

### Overview

A connection network system may provide access to a large amount of electronic content aimed at professional networking and career development. For example, a connection network system may list employment opportunities posted by employers across different industries, professional profiles with detailed information about users of the connection network system (e.g., work experience, skills, and endorsements), articles or posts created by users and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where users can share ideas and discuss industry trends, and other types of content designed to facilitate professional growth and industry engagement.

A connection network system collects a variety of data associated with various entities (e.g., users, members, companies, organizations, etc.) of the platform in accordance with privacy policies which govern how this information is collected, used, and shared. For entities such as users or members of a connection network system, user data includes basic profile information such as name, job title, industry, location, educational background, and work history. Additionally, the connection network system may collect activity data for users representing various interactions and behaviors that users exhibit while on the platform. Examples of activity data include profile updates, content engagement, search and navigation behavior, job activities, networking activities, group participation, skill endorsements and recommendations, advertisement engagement, learning activities, event participation, followers activities, interactions with external content, engagement patterns, behavioral trends, and so forth.

In some cases, a connection network system may enhance network services offered by the connection network system based on the user data and activity data of its users. Examples of network services include messaging services, search services, ranking services, recommendation services, advertising services, content delivery services, and so forth. For example, a connection network system may use activity data to personalize user experiences, optimize content displayed in feeds, improve targeted advertising, and enhance platform features. It also plays a role in developing analytics and reporting tools, helping users and businesses understand their network reach, content effectiveness, and engagement with their audience.

A connection network system may offer a content delivery system that delivers electronic content items to users based on user data and activity data. For example, the content delivery system may recommend content items such as posts or articles for a user feed based on group participation, educational courses for a skill based on job title, or upcoming events based on previously attended events. In particular, the content delivery system may deliver content items such as advertisements (ads) specifically targeted to an audience of users based on user data or activity data. For instance, a content producer such as a digital advertiser may create a marketing campaign to deliver a series of digital advertisements for a product or service to an audience of users of the connection network system. The marketing campaign is designed to deliver different content items at various marketing “touchpoints.” A touchpoint refers to any interaction or point of contact between a content item and its intended audience. This can include various forms such as ad impressions, clicks on an ad link, engagement with interactive elements, social media interactions, application installations triggered by ads, and more. Each touchpoint is crucial for understanding user behavior and optimizing campaign performance. Additionally, touchpoints can be used to track the customer journey across different platforms and channels. This data helps marketers create cohesive strategies that engage users at multiple stages of their decision-making process, ultimately leading to increased conversion rates and return on investment (ROI).

Determining whether a given content item is of interest or relevant to a user remains a difficult and complex technical problem. For example, each touchpoint may deliver a content item that provides different types of information about a product or service. However, selecting a content item to present at a given touchpoint with a certain type of information about the product or service depends on a host of factors, such as knowledge about the user, activity of the user, interests of the user, intent of the user, a campaign, a content item, a delivery system, an electronic device, a user interface, spatial dimensions of an electronic display, and other factors. Further, some marketing campaigns are specifically designed to obtain a conversion event, such as a user completing a purchase of the product or the service. A given marketing sequence of content items may be relevant to the conversion event. For example, delivering an advertisement with general information about a product or service is less impactful in the middle of a sequence relative to the start of a sequence. Conversely, delivering an advertisement with specific information about a product or service is less impactful at the start of a sequence relative to the end of a sequence. Therefore, identifying a content item that is relevant to a given user within the marketing sequence has a time dimension that must be considered. Other technical challenges include identifying an audience of users relevant to a given marketing campaign using an iterative audience expansion (AE) process to determine a performant audience (PA) segment, identifying a PA segment from among millions or billions of users of a connection network system in a technically efficient manner, managing a large number of marketing campaigns (e.g., often hundreds of thousands) in various stages of AE simultaneously and in parallel using servers in different geolocations around the world, conserving resources for high-performance computing (HPC) platforms, managing bandwidth and other network considerations (e.g., packet size, latency, encryption, security, etc.), managing campaign attributes associated with a marketing campaign (e.g., such as a campaign start date, campaign stop date, number of advertisements, target demographics, types of products and/or services, geo-locations, languages, and so forth), and a host of other technical challenges. Balancing such factors to efficiently and effectively select a particular content item for a given content delivery campaign is a complex and imprecise endeavor, often consuming a large amount of HPC resources and taking hours or even days (at scale) to accomplish even on modern computing systems.

Embodiments solve these and other technical challenges. Embodiments are generally directed to AI and ML techniques to support various network services for an online connection network system. Some embodiments are particularly directed to a novel AI architecture and framework that implements various ML models trained and deployed to perform inferencing operations in support of a network service. Non-limiting examples of network services include search services, ranking services, recommendation services, advertising services, content delivery services, and other types of network services.

In various embodiments, a connection network system may use an improved content delivery system to provide a content delivery service to various entities (e.g., individuals, users, members, agents, groups, etc.). The content delivery system is generally designed to deliver electronic content items to entities such as users based, at least in part, on user data for users of the connection network system, activity data of the users, and trajectory data associated with the users. In particular, the content delivery system may deliver content items such as digital advertisements specifically targeted to an audience of users based on the user data, activity data, and trajectory data. For instance, a content producer such as a digital advertiser may create a marketing campaign to deliver a series of content items in the form of digital advertisements over a period of time for a product or service of a business entity to an audience of users of the connection network system.

In various embodiments, the content delivery system may train and deploy one or more machine learning (ML) models to perform various downstream tasks in support of advertising services for the connection network system. For example, the content delivery system may use multiple ML models to automatically identify content items (e.g., digital advertisements) from a set of content items for a given content delivery campaign that are interesting and relevant to a user of the connection network system. Examples of a content delivery campaign includes a marketing campaign or an advertising campaign. Examples of a content producer includes a user, an advertiser, or a business entity.

In particular embodiments, a connection network system comprises a connection network platform to execute a content delivery system. The content delivery system comprises a content delivery application and one or more ML models to support the content delivery application. A non-limiting example of a suitable ML model, among other types of ML models, comprises a decision transformer. In some embodiments, the decision transformer may be implemented as a single ML model. In some embodiments, the decision transformer may be implemented with other ML models, where the decision transformer is a single tower in a multi-tower ML model. Embodiments are not limited in this context.

A decision transformer is an innovative approach that combines the powerful sequential processing capabilities of transformer architectures with the principles of reinforcement learning. This integration allows for the modeling of decision-making processes in environments where actions are based on historical data. By leveraging the strengths of transformers, decision transformers enable offline reinforcement learning, reducing the need for resource-intensive online training and allowing agents to learn from existing datasets. Moreover, decision transformers address the challenge of long-term dependencies in reinforcement learning by managing complex sequential data and generating future action sequences to optimize reward outcomes. This cutting-edge approach has significant implications for various applications in a connection network system, such as ranking content items to tailor user content item recommendations, influence user habits, improve user experiences, and ultimately increase long-term revenue.

In some embodiments, for example, an embedding layer of the decision transformer receives a first vector comprising a set of entity trajectory features associated with an entity identifier of the connection network system. The embedding layer generates entity trajectory embeddings for the decision transformer. For example, the embedding layer generates a first entity trajectory embedding from the set of entity trajectory features. The first entity trajectory embedding comprises a sequence of values representing a first state, a first action, and a first reward (or return). The decision transformer receives the first entity trajectory embedding as input, and it generates a predicted action embedding based on the entity trajectory embedding. The predicted action embedding comprises values representing a predicted action to achieve a total reward given historical data, such as the first state, the first action, and the first reward. The content delivery application uses the predicted action, either alone or in combination with other information or embeddings, to select a target content item from a set of content items for a content delivery campaign based on the predicted action embedding. The content delivery application then causes presentation of the target content item on a user interface of an electronic device, such as a client device of a user identified by the entity identifier.

In some embodiments, the decision transformer treats a reinforcement learning problem as predicting a next action in a sequence, given states, actions, rewards, and a desired future reward (e.g., a total reward). Following this model, the entity trajectory embedding comprises a sequence of rewards, states, and actions, from which the decision transformer outputs a next action to take in the sequence. Continuing with the previous example for a content delivery application, the entity trajectory embedding comprises a first state, a first action, and a first reward. For example, the first state comprises a content item from the set of content items, the first action comprises an impression or a click of the content item, and the first reward comprises a reward tuple of clicks, impressions, and rewards associated with the entity identifier and a content delivery campaign. The decision transformer then outputs a next action for the content delivery application to take in the sequence given states, actions, rewards, and a target reward (or target return) encoded into the entity trajectory embedding. For example, the next action may be selection of a content item to present to a user in a series of content items for a marketing campaign that maximizes a future reward to achieve a target objective, such as a conversion event for purchasing a product or service.

In some embodiments, the content delivery application receives feedback information from a user when a user interface surfaces the next content item for viewing. For example, the content delivery application receives a signal of an action from a user interface element of the user interface in response to the presentation of the target content item on the user interface of the electronic device associated with the entity identifier. For example, a user may view or select the target content item to obtain further information about the product or service. The content delivery application stores the target content item as a second state associated with the entity identifier, stores the action as a second action for the target content item associated with the entity identifier, and calculates a second reward based on the second state and the second action. The embedding layer generates a second entity trajectory embedding associated with the entity identifier by the embedding layer, the second entity trajectory embedding comprising a sequence of values representing the second state, the second action, and the second reward. The decision transformer receives the second entity trajectory embedding as input, and it generates a second predicted action embedding based on the second entity trajectory embedding. The second predicted action embedding comprises values representing a predicted action to achieve the total reward given the second state, the second action, and the second reward. The content delivery application uses the second predicted action, either alone or in combination with other information or embeddings, to select a new target content item from the set of content items for a content delivery campaign based on the predicted action. The content delivery application then causes presentation of the new target content item on the user interface of the electronic device, such as the client device of the user identified by the entity identifier.

The content delivery application continues this process in an iterative manner until a terminating condition occurs. Non-limiting examples of a terminating condition includes when a conversion event is reached, purchase of a product or service, purchase of another product or service, termination of interest by the user in the product or service, a reset of the content delivery campaign, a termination of the content delivery campaign, expiration of a defined time parameter, a defined threshold number of advertisements are delivered, or some other terminating condition. Embodiments are not limited to these examples.

The embodiments disclosed herein provide several technical solutions to technical problems faced by conventional systems. For example, estimating the probability that a user clicking on a content item is an essential task in digital advertising. This ensures that relevant content items are shown to the right audience, optimizes placements of content items on a user interface, maximizes revenue for content delivery campaigns, and enhances the overall user experience. Traditional models, however, are limited to capturing short term behavior such as individual events. Embodiments use a multi-tower ML model that includes a decision transformer as a tower to capture intricate patterns of user behavior over time. Understanding these patterns is important because user behavior is often influenced by a sequence of interactions, not just individual events. For example, how a user engages with content items can change based on their past experiences, preferences, or even current trends. To address these limitations, embodiments integrate decision transformers, either separately or as part of a multi-tower ML model. Unlike traditional models that simply optimize for the next click, decision transformers model a sequence of user actions and states, considering the longer-term trajectory of user behavior. This means decision transformers can optimize for a series of actions (e.g., multiple clicks and interactions), focusing on achieving holistic goals such as maximizing overall user engagement, lifetime revenue or long term revenue clicks. By finding a policy that maximizes cumulative rewards over a trajectory, decision transformers provide a more comprehensive understanding of user behavior and improve long-term ad targeting strategies. This approach leads to better user experiences and improved business outcomes. Using a decision transformer, the model looks at how showing different content items over time can keep a user engaged and lead to valuable actions. For instance, if the user has clicked on job-related advertisements before, the decision transformer might show a mix of job advertisements and career advice articles. This approach keeps the user engaged longer, leading to better overall outcomes for both the user and advertisers. Embodiments provide other technical solutions to other technical problems as well.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### DETAILED EMBODIMENTS

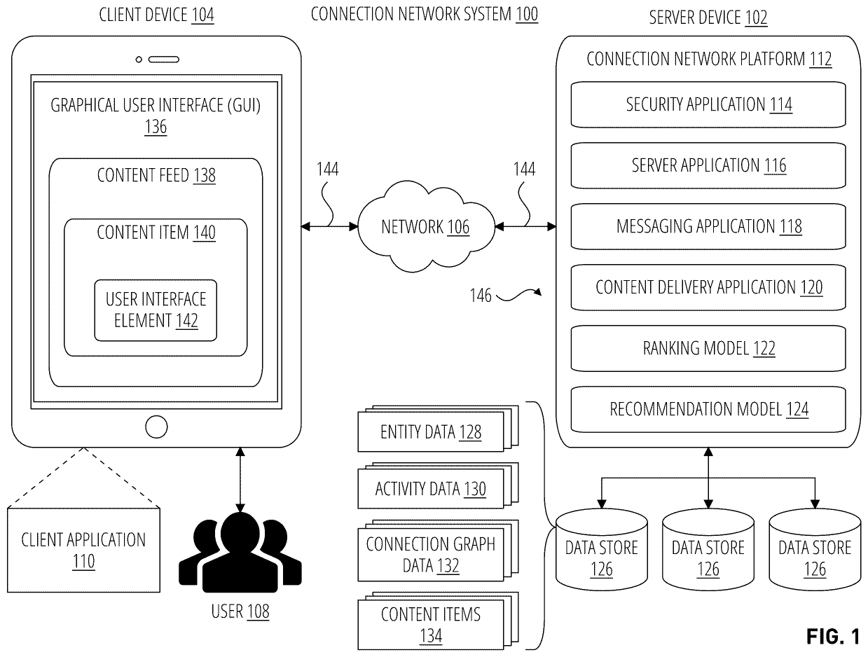

FIG. 1 illustrates a connection network system 100. The connection network system 100 is an example of an architecture or framework for an online computer and communications system designed to serve content items to an electronic device associated with a user. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. In operation, a user 108 interacts with a client application 110 of the client device 104 to access applications and services provided by a connection network platform 112 of the server device 102. The connection network platform 112 offers a number of network services 146 for the connection network system 100, such as network services provided by a security application 114, a server application 116, a messaging application 118, a content delivery application 120, a ranking model 122, and/or a recommendation model 124. The server device 102 has access to one or more data stores 126. The data stores 126 store information for the connection network platform 112, such as entity data 128, activity data 130, connection graph data 132, and content items 134.

The connection network system 100 comprises a server device 102. In particular embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network user 108 at a client device 104 via the network 106. A client device 104 may enable its user 108 to communicate with other users 108 at the server device 102, such as via messaging applications 118.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about a user's actions on or off the connection network platform 112. In conjunction with the action log, a third-party-content-object log may be maintained of user exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the users of the connections networking system. A privacy setting of a user determines how particular information associated with a user can be shared. The authorization server may allow users to opt in to or opt out of having their actions logged by the connection net work platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with users. Advertisement-pricing modules may combine connections information, the current time, location information, or other suitable information to provide relevant advertisements, in the form of notifications, to a user.

The connection network system 100 comprises a connection network platform 112. In particular embodiments, the connection network platform 112 may be part of a network-addressable computing system that can host an online connection network. The connection network platform 112 may generate, store, receive, and send connection networking data, such as, for example, entity data 128 (e.g., user-profile data, concept-profile data, etc.), activity data 130 (e.g., user interactions with connection network platform 112), connection graph data 132 (e.g., connections between users or entities), content items 134, or other suitable data related to the online connection network. The connection network platform 112 may be accessed by the other components of the connection network system 100 either directly or via a network 106. As an example and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 comprises a security application 114. In particular embodiments, a security application 114 may be an application or electronic device including hardware, software, or embedded logic components or a combination of two or more such components and capable of carrying out the appropriate functionalities implemented or supported by the security application 114. The security application 114 is a network security system that encompasses a suite of technologies, policies, and practices designed to protect the integrity, confidentiality, and availability of data within the connection network platform 112 from unauthorized access, attacks, and other security threats. The security application 114 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 114 implements security practices to ensure a robust defense against a wide array of cyber threats, safeguarding organizational assets and maintaining trust with stakeholders.

The connection network platform 112 comprises a server application 116. In particular embodiments, the server application 116 may be a web server to serve content information, such as content items 134, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the user 108.

In particular embodiments, the server application 116 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 116 may be an e-commerce application, a content application, an advertisement application, a web interface, a messaging application, a video application, a webpage, and so forth.

In particular embodiments, the server application 116 may be an application for managing various applications and services provided by the online connection network hosted on the connection network platform 112. In particular embodiments, the server application 116 may include hardware, software, or embedded logic components or a combination of two or more such components for carrying out the appropriate functionalities implemented or supported by connection network platform 112. Although the server device 102 is shown with a single server application 116, it should be noted that this is not by any way limiting and this disclosure contemplates any number of server applications 116.

The connection network platform 112 comprises a messaging application 118. The messaging application 118 is software that enables users to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 112 comprises a content delivery application 120. The content delivery application 120 is a software tool that allows users to efficiently deliver content items to other users of the connection network platform 112 of the connection network system 100, such as content items 134 stored by one or more data stores 126 or third-party content servers. An example for the content delivery application 120 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 120 allows advertisers to create, manage, and analyze their ad campaigns on the platform in accordance with a larger programmatic advertising strategy. It allows for precise targeting based on entity data 128 and/or activity data 130, making it especially useful for business-to-business (B2B) or business-to-consumer (B2C) marketing campaigns. The content delivery application 120 delivers content items 134, such as a series of one or more advertisements, to an audience of users 108 of the connection network platform 112 of the connection network system 100. The content delivery application 120 assist advertisers in delivering content and ads to a professional audience by leveraging user profiles, job titles, industries, and other entity data 128 and activity data 130 collected by the connection network platform 112.

The connection network platform 112 comprises various machine learning (ML) models, such as a ranking model 122. A ranking model 122 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to users.

The connection network platform 112 comprises various ML models, such as a recommendation model 124. A recommendation model 124 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 102 comprises, or has access to, one or more data stores 126. In particular embodiments, the connections networking system 102 may include a data store 126. The data store 126 may be used to store various types of information for the server device 102 and/or the connection network platform 112. In particular embodiments, the information stored in the data store 126 may be organized according to specific data structures. In particular embodiments, the data store 126 may be a relational, columnar, correlation, or other suitable database. Although this disclosure describes or illustrates particular types of databases, this disclosure contemplates any suitable types of databases. Particular embodiments may provide interfaces that enable a client device 104 or a connection network system 100 to manage, retrieve, modify, add, or delete, the information stored in the data store 126.

In one embodiment, for example, the data store 126 stores entity data 128 for the connection network platform 112. In particular embodiments, the connection network platform 112 may include entity data 128 for various entities of the connection network platform 112. Non-limiting examples of entities may include users, individuals, members, businesses, companies, organizations, software agents, hardware agents, and so forth. For example, the entity data 128 may comprise one or more user profiles associated with users of the connection network platform 112. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 126 stores activity data 130 for the connection network platform 112. The activity data 130 represents various activities recorded for a user 108 by the connection network platform 112. In particular embodiments, the connection network platform 112 may provide entities (e.g., users) with the ability to take actions on various types of items or objects supported (or accessible) by connection network platform 112. As an example and not by way of limitation, the items and objects may include groups or connections networks to which users of the connection network platform 112 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 112 or by an external system of a third-party system, which is separate from the server device 102 and coupled to the server device 102 via a network 106.

In one embodiment, for example, the data store 126 stores connection graph data 132 for the connection network platform 112. The connection network platform 112 may store connection graph data 132 for one or more users (e.g., members with subscription accounts) of the connection network platform 112. In one embodiment, for example, connection graph data 132 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 112 may provide users of the online connection network system 100 the ability to communicate and interact with other users. In particular embodiments, users may join the online connection network platform 112 via the connection network system 100 and then add connections (e.g., relationships) to a number of other users of the connection network platform 112 to whom they want to be connected. Herein, the term “connection” may refer to any other user of the connection network platform 112 or the connection network system 100 with whom a user has formed a friendship, association, or relationship via the connection network platform 112.

In one embodiment, for example, the data store 126 stores content items 134 for the connection network platform 112. The content items 134 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 112 also includes user-generated content (UGC) objects, which may enhance a user's interactions with the connection network platform 112. User-generated content may include anything a user can add, upload, send, message, or “post” to the connection network platform 112. As an example and not by way of limitation, a user communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network user at a client device 104 to access a network 106. A client device 104 may enable its user 108 to communicate with other users 108 at other client devices 104, such as via messaging application 118.

The connection network system 100 comprises a client application 110. In particular embodiments, a client device 104 may include a client application 110, which may be a web browser, and may have one or more add-ons, plug-ins, or other extensions. A user 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the user 108. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 118 for messaging with users 108 of a messaging network or system, a web browser application, an internet searching application, and so forth.

In particular embodiments, the client application 110 may be storable in a memory and executable by a processor circuitry of the client device 104 to render user interfaces, receive user input, send data to and receive data from the connection network platform 112. The client application 110 may generate and present user interfaces to a user via an electronic display of the client device 104. For example, the client application 110 may generate and present a GUI 136 based at least in part on information received from the server device 102, the connection network platform 112, and/or another device or system (e.g., a third party server) via the network 106.

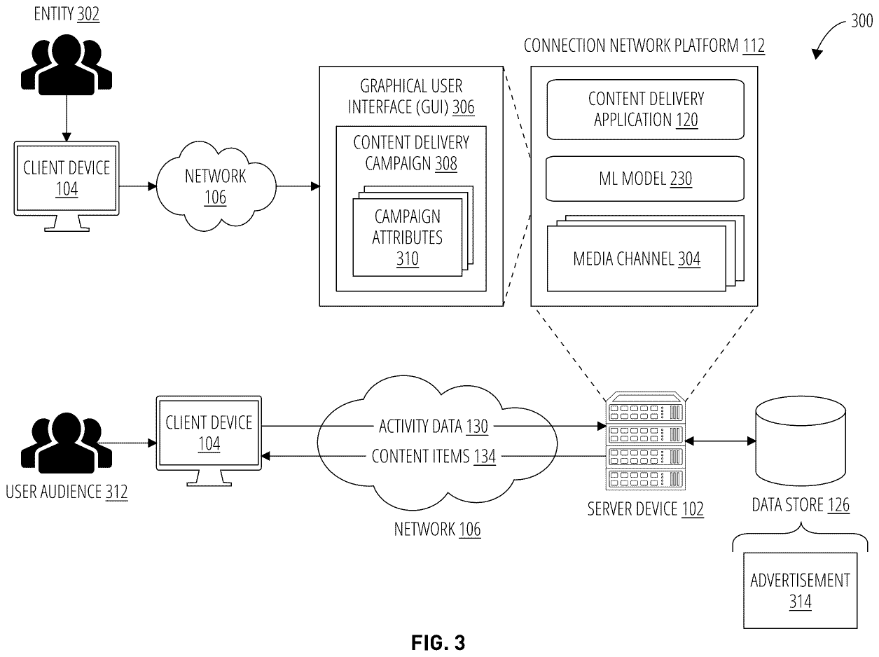

In some embodiments, the connection network platform 112 and/or the client application 110 and/or an operating system of the client device 104 may generate a GUI 136 on an electronic display of the client device 104. The client application 110 may receive one or more content items 134 from the data store 126 of the connection network platform 112 from the content delivery application 120. The client application 110 may display the content items 134 as content item 140 on a content feed 138 of the GUI 136. The content item 140 may include a user interface element 142 that when selected or activated by the user 108, causes the GUI 136 to generate a signal such as a message for delivery to the content delivery application 120 of the connection network platform 112. The signal or message may comprise a feedback signal to the content delivery application 120 for use by the content delivery application 120 to select a new content item from the data store 126 for delivery to the client device 104. For example, the content delivery application 120 may use the feedback signal as part of an ML model to select content items 134 for a marketing campaign managed by the content delivery application 120, as described in more detail with reference to FIG. 3.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, a user 108 interacts with a client application 110 of the client device 104 to access applications and services provided by a connection network platform 112 of the server device 102 via one or more links 144 of the network 106. The links 144 may connect each client device 104 to the connection network platform 112 via the network 106. This disclosure contemplates any suitable link 144. In particular embodiments, one or more links 144 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 144 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 144, or a combination of two or more such links 144. Links 144 need not necessarily operate at the same throughout. One or more first links 144 may differ in one or more respects from one or more second links 144.

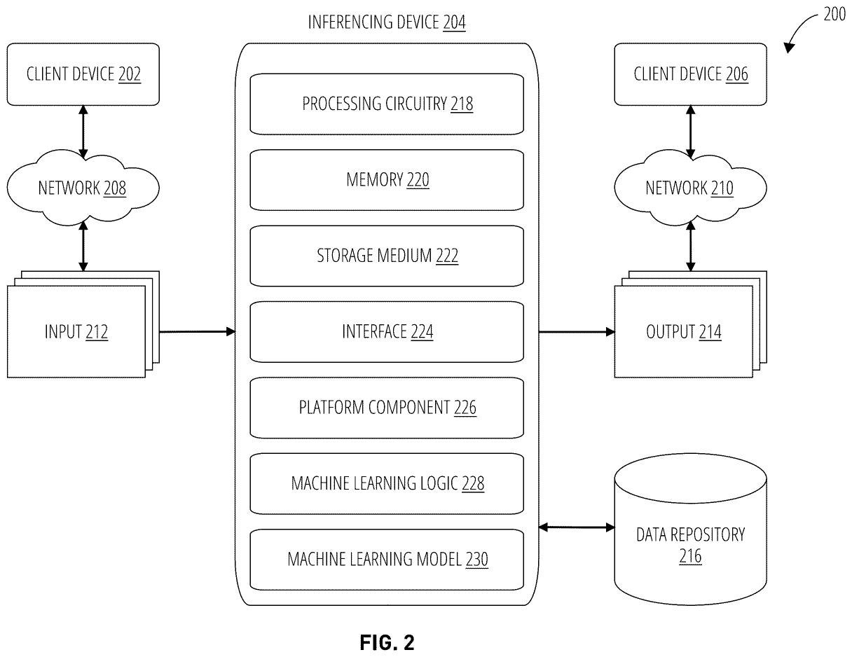

FIG. 2 illustrates an embodiment of a system 200. The system 200 is suitable for implementing one or more embodiments as described herein. In one embodiment, for example, the system 200 is an AI/ML system suitable for implementing models described with reference to any of the preceding description.

The system 200 comprises a set of M devices, where M is any positive integer. FIG. 2 depicts three devices (M=3), including a client device 202, an inferencing device 204, and a client device 206. The inferencing device 204 communicates information with the client device 202 and the client device 206 over a network 208 and a network 210, respectively. The information may include input 212 from the client device 202 and output 214 to the client device 206, or vice-versa. In one alternative, the input 212 and the output 214 are communicated between the same client device 202 or client device 206. In another alternative, the input 212 and the output 214 are stored in a data repository 216. In yet another alternative, the input 212 and the output 214 are communicated via a platform component 226 of the inferencing device 204, such as an input/output (I/O) device (e.g., a touchscreen, a microphone, a speaker, etc.).

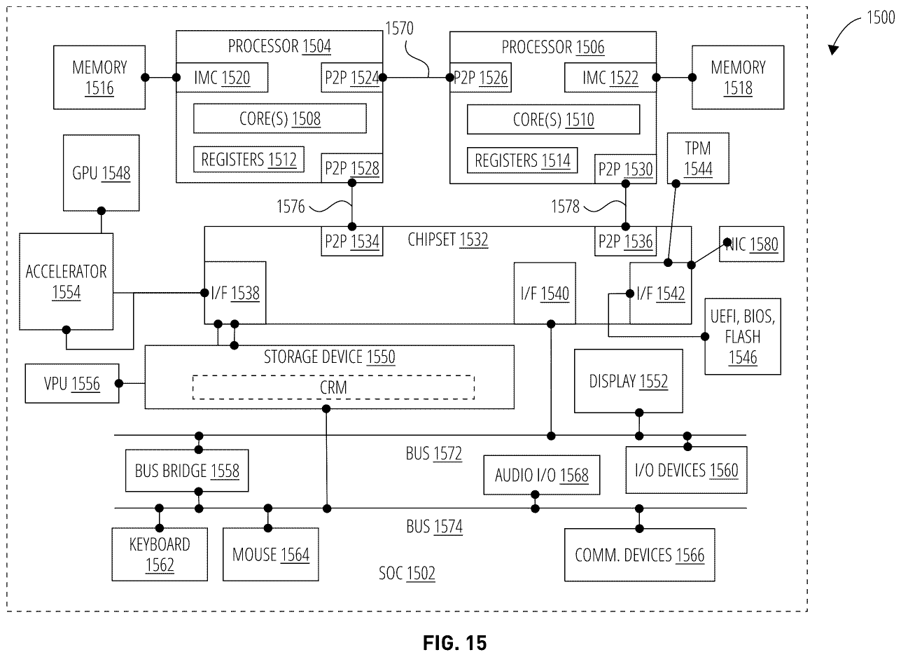

As depicted in FIG. 2, the inferencing device 204 includes processing circuitry 218, a memory 220, a storage medium 222, an interface 224, a platform component 226, ML logic 228, and an ML model 230. In some implementations, the inferencing device 204 includes other components or devices as well. Examples for software elements and hardware elements of the inferencing device 204 are described in more detail with reference to a computing architecture 1500 as depicted in FIG. 15. Embodiments are not limited to these examples.

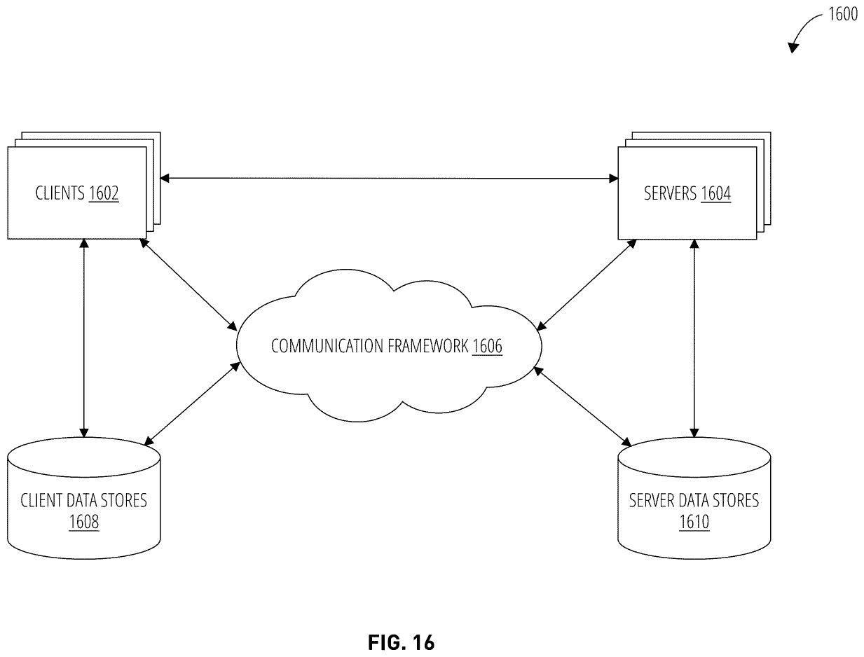

The inferencing device 204 is generally arranged to receive an input 212, process the input 212 via one or more AI/ML techniques, and send an output 214. The inferencing device 204 receives the input 212 from the client device 202 via the network 208, the client device 206 via the network 210, the platform component 226 (e.g., a touchscreen as a text command or microphone as a voice command), the memory 220, the storage medium 222 or the data repository 216. The inferencing device 204 sends the output 214 to the client device 202 via the network 208, the client device 206 via the network 210, the platform component 226 (e.g., a touchscreen to present text, graphic or video information or speaker to reproduce audio information), the memory 220, the storage medium 222 or the data repository 216. Examples for the software elements and hardware elements of the network 208 and the network 210 are described in more detail with reference to a communications architecture 1600 as depicted in FIG. 16. Embodiments are not limited to these examples.

The inferencing device 204 includes ML logic 228 and an ML model 230 to implement various AI/ML techniques for various AI/ML tasks. The ML logic 228 receives the input 212, and processes the input 212 using the ML model 230. The ML model 230 performs inferencing operations to generate an inference for a specific task from the input 212. In some cases, the inference is part of the output 214. The output 214 is used by the client device 202, the inferencing device 204, or the client device 206 to perform subsequent actions in response to the output 214.

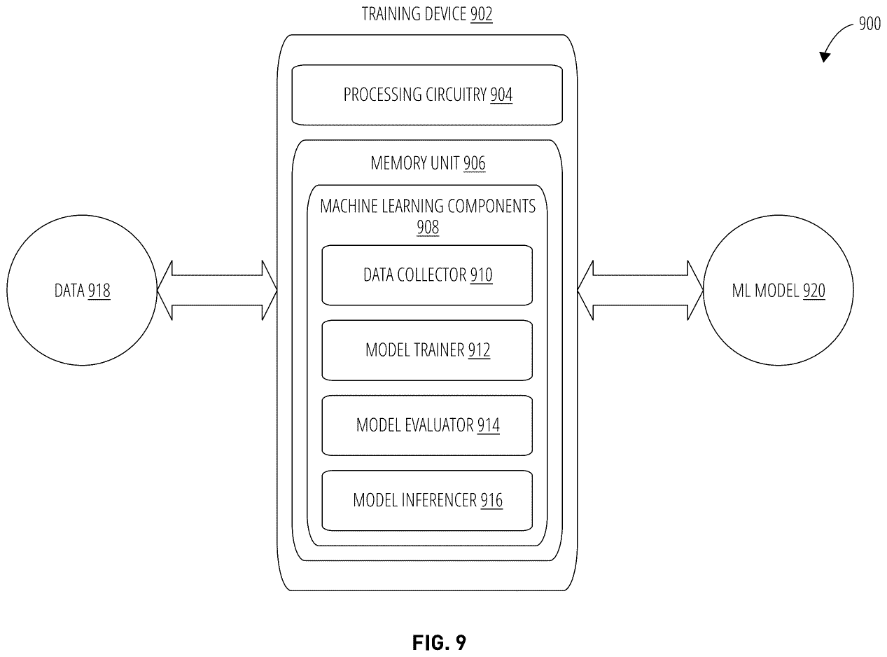

In various embodiments, the ML model 230 is a trained ML model 230 using a set of training operations. An example of training operations to train the ML model 230 is described with reference to FIG. 9.

FIG. 3 illustrates a content delivery system 300. The content delivery system 300 is an example of a system designed to deliver one or more content items 134 such as one or more advertisements 314 to a user audience 312 of one or more users 108 of the connection network platform 112 of the connection network system 100. The content delivery system 300 delivers the advertisements 314 in a targeted manner. The content items 134 may comprise, for example, recommendations, advertisements, content, messages, suggestions, hyperlinks, files, job postings, articles, and any other content offered by the connection network platform 112 of the connection network system 100.

In various embodiments, the connection network system 100 may use the content delivery system 300 to provide a content delivery service via a content delivery application 120 (e.g., software as service (SaaS)) to its users 108 (e.g., individuals, members, entities, groups, etc.). The content delivery system 300 is generally designed to deliver electronic content items 134 to users 108 based, at least in part, on entity data 128 and activity data 130 of users 108 of the connection network system 100. In particular, the content delivery system 300 may deliver content items 134 such as advertisements 314 specifically targeted to an audience of users 108 based on entity data 128 or activity data 130. For instance, a content producer such as an advertiser may create a content delivery campaign such as a marketing campaign or advertising campaign to deliver a series of advertisements 314 for a product or service of a business entity to an audience of users 108 of the connection network system 100 over a defined time interval (e.g., weeks, days, months, etc.).

The content delivery system 300 comprises a set of one or more client devices 104, server devices 102, and data stores 126. A client device 104 and a server device 102 may communicate information via a network 106. The client device 104 may comprise an electronic device, such as a smartwatch, smartphone, tablet, laptop computer, desktop computer, and so forth. The server device 102 may be implemented as a server in a data center, such as a cloud computing system or edge computing system. The client device 104 and the server device 102 may be implemented using an architecture as described in FIG. 15. The network 106 may be implemented using an architecture as described in FIG. 16. Embodiments are not limited to these example implementations.

The server device 102 implements a connection network platform 112 as described with reference to FIG. 1. In one embodiment, the connection network platform 112 includes at least one processor circuitry, at least one memory unit operably coupled to the processor circuitry, the memory unit including instructions executable by the at least one processor circuitry, and an ML model 230 comprising parameters and/or hyperparameters stored in the at least one memory unit. In one embodiment, for example, the ML model 230 is implemented as a two-tower ML model for an AI system implemented by the content delivery system 300 to offer a network service such as a content delivery service by the content delivery application 120 of the connection network platform 112. The content delivery application 120 may select one or more content items 134, such as advertisements 314, for delivery as targeted content over one or more media channels 304 to a client device 104. A user 108 from the user audience 312 may interact with a graphical user interface (GUI) to access the targeted content for presentation on the client device 104.

The server device 102 may include connection network platform 112 implementing a network service to user 108 of the connection network platform 112. Professional networking platforms offer a wide range of networking services to facilitate connections, career development, and knowledge sharing. Some examples of a network service offered by the connection network platform 112 include without limitation: (1) users can create a professional profile to showcase their skills, work experience, education, and professional accomplishments; (2) users can connect with colleagues, industry professionals, and potential employers to expand their professional network; (3) messaging capabilities for direct communication between users, facilitating professional conversations and networking opportunities; (4) users can join and participate in industry-specific groups and communities to engage in discussions, share insights, and network with like-minded professionals; (5) search job listings and recruiting tools for users to search for employment opportunities, apply for jobs, and connect with talent; (6) users can share industry-related content, articles, and professional updates to showcase expertise and engage with their network; and (7) access learning resources, courses, and training programs to support ongoing professional development and skill enhancement. These networking services are designed to help professionals connect, collaborate, and grow their careers. Embodiments are not limited to these examples.

In an example process, the connection network platform 112 obtains activity data 130 from users 108 via the client device 104. The users 108 interact with the connection network platform 112 via a user interface of the connection network platform 112. In some cases, portions of the user interface are displayed on a personal machine or client device 104 of a user 108. The activity data 130 represents various actions, activities or behaviors of one or more users 108 of the user audience 312. For example, activity data 130 may represent data collected as the users 108 interact with various content items 134, such as advertisement 314, of the data store 126 served via the server device 102. In another example, the activity data 130 may represent data collected as the users 108 interact with other products or services offered by the connection network platform 112, such as searching for job postings, sending messages to users 108, recommending posts by users 108, sending and responding to connection requests, playing online games, and other activities organic to use of the connection network platform 112. Session data is any activity data 130 collected during a defined session time window, such as activity of the user over a 24 hour period or some other time interval. For example, a user 108 of the user audience 312 may interact with the client device 104 to communicate with the connection network platform 112 of one or more of the server devices 102 to access one or more content items 134 stored by the data store 126. The users 108 may perform various activities, such as browsing a web site, searching for a job posting, reading content, watching a streaming video, messaging other members, clicking on an GUI item, interacting with an advertisements, or engaging in electronic commerce. The session data, including the activity data 130, is transferred between the client device 104 and the server device 102.

More particularly, the connection network platform 112 comprises the content delivery application 120, which includes or accesses an ML model 230 such as a two-tower ML model, and data for one or more media channels 304. The content delivery application 120 is responsible for delivery of targeted content based on activity data 130 and/or session data associated with the users 108 of the user audience 312. The content delivery application 120 uses the ML model 230 to support such activities. The content delivery application 120 then targets delivery of specific content items 134 to users within user segments, such as advertisements 314 for the user audience 312, over one or more media channels 304. The targeted content is a content item that is relevant to the user audience 312 or the user audience 312 segment, such as messages, predictions, recommendations, advertisements, or suggestions to improve user experience.

The targeted content is delivered through one or more of the media channels 304. A media channel refers to a specific platform or medium through which targeted content, such as advertisements, are disseminated to a target user. Media channels 304 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively, message provider, such as advertisers, often choose certain media channels based on factors such as user engagement, reach, cost, and the compatibility of the channel with their target market. An example of the media channel 304 is a social media platform or a professional media platform, or some other mode of information transfer within the platform.

The connection network platform 112 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

The data store 126 is an organized collection of data. For example, the data store 126 stores data in a specified format known as a schema. The data store 126 can be structured as a single database, a distributed database, multiple distributed databases, or an emergency backup database. In some cases, a database controller manages data storage and processing in data store 126. In some cases, a user interacts with the database controller. In other cases, the database controller operates automatically without user interaction. The data store 126 is configured to store various content items 134. The content items 134 include any multimedia information suitable for presentation by the client device 104, such as HTML code to present websites, text, images, video, messages, advertisements, and so forth. In addition, the data store 126 may also store application data comprising information and data used by the connection network platform 112. For example, data store 126 is configured to store user session data, profiles, embeddings, budgets, cached application programming interface (API) requests, machine learning model parameters, training data, and other data.

Network 106 facilitates the transfer of information between connection network platform 112, data store 126, and client device 104. Network 106 is a computer network configured to provide on-demand availability of computer system resources, such as data storage and computing power. In some examples, the network 106 provides resources without active management by the users 108. The network 106 includes data centers available to many users over the Internet. Some large cloud networks have functions distributed over multiple locations from central servers. A server is designated an edge server if it has a direct or close connection to a user 108. In some cases, a cloud is limited to a single organization. In other examples, the cloud is available to many organizations. In one example, the network 106 includes a multi-layer communications network comprising multiple edge routers and core routers. In another example, the network 106 is based on a local collection of switches in a single physical location.

In particular embodiments, the content delivery system 300 uses multiple ML models 230 to support various downstream tasks for the content delivery application 120. For example, the content delivery application 120 may use an ML model 230 implemented as a decision transformer to use historical information about entities 302, activity data 130 for entities 302, content items 134, campaign attributes 310, and other types of historical information stored by the connection network system 100 to identify, select and deliver future content items 134 to the client device 104 of an entity 302 or user audience 312.

In particular embodiments, the content delivery system 300 uses multiple ML models 230 to support an auto-targeting (AT) task and an audience expansion (AE) task for a content delivery campaign 308 on behalf of a content producer, such as an advertiser. For example, the content delivery system 300 may use an AT model for an AT task to select a seed audience for a content delivery campaign 308. The content delivery system 300 begins delivery of content items 134, such as advertisements 314, to users 108 of a user audience 312 (e.g., a seed audience). The content delivery system 300 collects activity data 130 of the users 108 of the user audience 312, such as user engagement with the advertisements 314 and other organic activities of users 108 as they interact with various products and services offered by the connection network platform 112, among other types of activity data 130. The content delivery system 300 uses an AE model for an AE task that periodically, aperiodically or continuously modifies the user audience 312 (e.g., adding or removing users) based on the collected activity data 130 to improve future user engagement with the advertisement 314. The AE model performs the AE task in an iterative manner until the content delivery system 300 identifies a user audience 312 comprising a performant audience (PA) segment for the content delivery campaign 308.

A PA segment for a content delivery campaign 308 such as an advertising campaign refers to a target group of individual users 108 who demonstrate high effectiveness in achieving campaign goals and objectives. These goals could include metrics such as conversions, click-through rates, engagement, or return on investment (ROI). In practical terms, a PA segment includes users 108 that are likely to engage with the advertisement 314 at a higher rate than the average audience, converts (e.g., makes a purchase, signs up for a service) more frequently, responds positively to the campaign call to action leading to measurable success, and/or aligns well with the product or service being advertised, showing a strong interest or need. Identifying and targeting a PA segment often involves analyzing data from past campaigns, using machine learning models to predict which segments are likely to perform well, and continuously optimizing the audience selection to improve campaign outcomes.

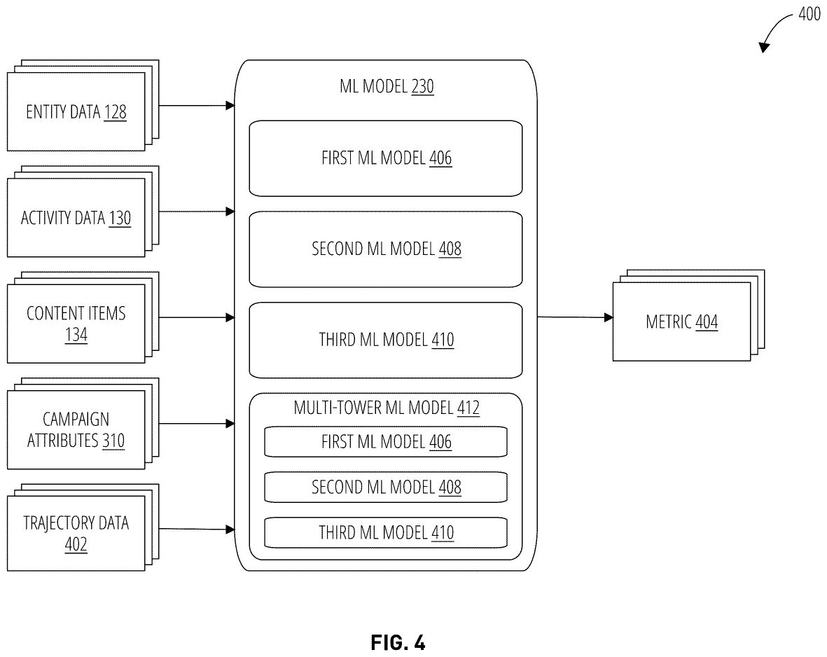

FIG. 4 illustrates a logic diagram 400. The logic diagram 400 is an example of a ML architecture or framework for an ML model 230 suitable for use by the content delivery application 120 of the content delivery system 300.

As depicted in FIG. 4, the logic diagram 400 comprises an ML model 230 receiving various types of input such as entity data 128, activity data 130, content items 134, campaign attributes 310, and/or trajectory data 402, either alone or in combination. The ML model 230 analyzes the inputs to recognize patterns, and it generates a metric 404 based on the recognized patterns. The ML model 230 may output at least two types of metrics 404. A first type for the metric 404 may comprise, for example, a value representing an immediate reward such as a predicted click-through-rate (pCTR) metric or universal pCTR metric. A pCTR metric estimates a probability of a user clicking on a content item. The pCTR is useful in selecting a content item for presentation to a user when the outcome is to receive a click or impression for the content item. A second type for the metric 404 may comprise, for example, a value representing a longer term reward, such as a long term pCTR (LT-pCTR) metric. A LT-pCTR metric estimates a next action in a sequence to maximize a given total reward or total return, as defined by a user or a system. The LT-pCTR metric is useful in selecting a content item for presentation to a user when the outcome is to reach a target objective, such as a conversion event for a product or service. The content delivery application 120 may use one or both types of metrics when selecting a next content item to present to a given user for a given marketing campaign.

In some embodiments, the ML model 230 may be implemented as a single ML model, such as a first ML model 406, a second ML model 408, or a third ML model 410. When implemented as a single ML model, the ML model 230 may generate a metric 404.

In some embodiments, the ML model 230 may be implemented as multi-tower ML model 412 comprising multiple ML models. For example, the first ML model 406 is implemented as a first tower, the second ML model 408 is implemented as a second tower, and the third ML model 410 is implemented as a third tower. When implemented as the multi-tower ML model 412, the outputs from all three ML models are combined to generate a metric 404. In some cases, the outputs from all three ML models may be combined using another ML model 230 or a matching layer for an ML model 230.

In some embodiments, the first ML model 406, the second ML model 408, and/or the third ML model 410 may be implemented as a multi-layer perceptron (MLP). A MLP is a fundamental type of artificial neural network (ANN) used in machine learning for supervised learning tasks like classification and regression. It comprises multiple layers of nodes (also called neurons) organized in a sequential structure including an input layer, one or more hidden layers, and an output layer. The input layer receives the initial input data features. The hidden layers perform computations. These layers allow the network to learn complex patterns by introducing non-linear transformations. The output layer produces the final output predictions. Each neuron in one layer is typically connected to every neuron in the next layer through weighted connections, making it a fully connected network. The neurons process inputs by applying a weighted sum followed by an activation function, such as sigmoid, tanh, or Rectified Linear Unit (ReLU), to introduce non-linearity. MLPs are trained using a method called backpropagation, which involves forward propagating inputs to compute outputs, calculating the error between the predicted and actual outputs, and then backward propagating this error to adjust the weights. This process iteratively minimizes the loss function, optimizing the network's performance on the training data. Due to their ability to model complex relationships between inputs and outputs, MLPs are widely used in various applications, including image and speech recognition, natural language processing, and time-series forecasting. They serve as the foundational architecture for more advanced neural networks in deep learning.

In some embodiments, the first ML model 406 is implemented as a MLP designed to receive the entity data 128, the activity data 130, and the content items 134 as input. The first ML model 406 retrieves a set of features from the entity data 128, the activity data 130, and/or the content items 134, such as member-content item interaction features. The first ML model 406 analyzes the member-content item interaction features for patterns, and it outputs a member embedding.

In some embodiments, the second ML model 408 is implemented as a MLP designed to receive the content items 134 and the campaign attributes 310 as input. The second ML model 408 retrieves a set of features from the content items 134 and the campaign attributes 310, such as campaign-content item features. The second ML model 408 analyzes the campaign-content item features for patterns, and it outputs a campaign embedding.

In some embodiments, the third ML model 410 is implemented as a decision transformer designed to receive the entity data 128, activity data 130, the content items 134, and the trajectory data 402 as input. The third ML model 410 retrieves a set of features from the inputs, such as entity trajectory features. The third ML model 410 analyzes the entity trajectory features for patterns, and it outputs a predicted action embedding.

The member embedding, the campaign embedding, and/or the predicted action embedding are input to a matching layer. The matching layer may be implemented as a MLP or a layer of an MLP. The matching layer analyzes the inputs, either alone or in combination, and it generates the metric 404. The metric 404 is fed as an input to the content delivery application 120 for selecting a content item from a set of content items 134, ranking content items 134, recommending content items 134, or performing other network services 146 in support of the connection network platform 112 of the connection network system 100.

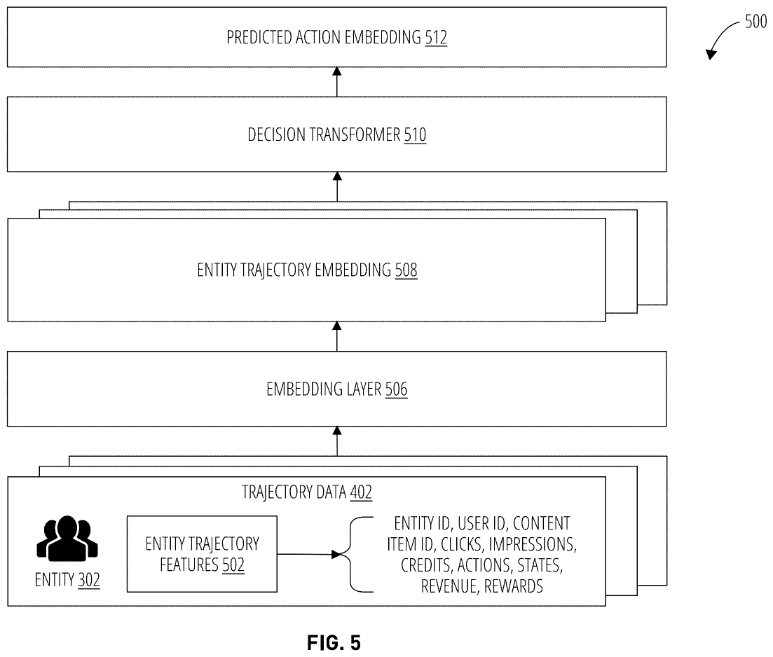

FIG. 5 illustrates an ML architecture 500. The ML architecture 500 is an example of a ML architecture or a ML framework for the ML models 230, such as the third ML model 410 implemented as a decision transformer, for example. The third ML model 410 may be implemented either alone or in combination with other ML models 230, such as the first ML model 406 and/or the second ML model 408 of the multi-tower ML model 412. Embodiments are not limited to these examples.

As previously described with reference to FIG. 4, the third ML model 410 is implemented as a decision transformer designed sequential data associated with an entity, such as a user of a connection network platform 112 of the connection network system 100. As described in more detail below, at each timestep, the decision transformer receives a combined embedding that encapsulates a reward-to-go, a current state, and a previous action. The embeddings are updated based on the actions taken and the resulting states and rewards. This process allows the decision transformer to consider a trajectory of an entity so far in a customer journey, and make informed predictions about the next best action to take in order to achieve a desired return such as a conversion event. Rather than focusing on a shorter term goal or immediate action, such as a probability of a user clicking on an ad, the decision transformer focuses on a longer term goal in a sequence of actions to obtain a target reward (or return), such as the next best ad to deliver to the user in order to achieve an ultimate goal of the user purchasing a product or service that is the subject of the marketing campaign.

In general, a decision transformer utilizes a transformer architecture, which is known for effectively processing sequential data. Transformers comprise multi-headed self-attention mechanisms and feed-forward neural networks, which enable the model to capture complex dependencies within the input data. The decision transformer learns from a dataset of state-action-reward (SAR) sequences, where each sequence represents the agent's interaction with the environment. These sequences are used to train the transformer in an offline reinforcement learning setting. The decision transformer uses the reward information embedded within the SAR sequences to predict the optimal actions that lead to the highest cumulative rewards. This reward-driven approach ensures that the generated action sequences align with the agent's goal of maximizing its rewards in the environment. To predict the optimal action, the decision transformer conditions its predictions on the current state and the history of states, actions, and rewards. This context conditioning allows the model to learn the relationships between past experiences and future actions, thus guiding the agent towards better decisions. The decision transformer operates in an offline reinforcement learning setting, where the agent learns from a pre-collected dataset of SAR sequences without actively exploring the environment. This approach reduces computational requirements and enables learning from diverse sources, such as human demonstrations or other agents' experiences. Leveraging the transformer's ability to generate future sequences, the decision transformer predicts the sequence of actions that will maximize the agent's cumulative reward.

As depicted in FIG. 5, the ML architecture 500 comprises an embedding layer 506, a set of entity trajectory embeddings 508, and a decision transformer 510. The embedding layer 506 receives as input a set of trajectory data 402 associated with one or more entities 302. The trajectory data 402 comprises raw information such as entity identifiers, content item identifiers, click data, impression data, reward data, revenue data, action data, state data, and other types of relevant data.

The ML architecture 500 obtains a set of entity trajectory features 502 from the trajectory data 402. The entity trajectory features 502 are input to the embedding layer 506, which outputs an entity trajectory embedding 508 for the entity 302. For example, the decision transformer 510 uses entity trajectory data obtained from the last K timesteps (or the most recent K events), where K represents any positive integer. The entity trajectory embedding 508 is denoted as (\hat{R}₁, s₁, a₁, \hat{R}₂, s₂, a₂, . . . . , \hat{R}_{K}, s_{K}, a_{K}), where \hat{R} represents an expected future returns-to-go, s represents states, and a represents actions.

Returns-to-go refers to the total expected future rewards that an agent, such as the content delivery application 120, anticipates receiving from a given point in time onward. This concept can be represented mathematically as Equation (1), as follows:

$${\hat{R}}_{t} = {\sum }_{{t}^{′} = t}^{T} {γ}^{{t}^{′} - t} {r}_{{t}^{′}} \qquad EQUATION ( 1 )$$

In Equation (1), r_{t′} represents the reward at time point t′, \hat{R}ₜ denotes the return-to-go (a discounted sum of future rewards), and γϵ|0,1] is the discount factor that assigns greater weight to nearer rewards. The returns-to-go value or embedding represents remaining rewards expected to achieve the desired total return. This approach enables the decision transformer 510 to guide agents toward actions that maximize long-term rewards (e.g., LT-pCTR) rather than focusing solely on immediate gains (e.g., pCTR). In the context of advertisements from pCTR modeling, these rewards can include metrics such as impressions (e.g., the number of times a content item is displayed to users), clicks (e.g., which occur when a user engages with the content item by selecting or clicking on it), and revenue generated from these interactions.

A state value or embedding represents the current situation or context of the environment with which the agent is interacting. In the use case of the content delivery application 120, the state might include various features such as user characteristics, previously shown content items (e.g., advertisements), past interactions (e.g., clicks or impressions), and so on.

An action value or embedding represents specific operations that an agent performs in response to a given state and its desired returns. In the use case of the content delivery application 120, an action involves selecting which advertisements to present to an entity 302 on a client device 104.

In some embodiments, the most recent K timesteps are input into the decision transformer 510, resulting in a total of 3000 tokens, with one token for each modality of return-to-go, state, and action. To obtain the entity trajectory embedding 508 (e.g., token embeddings), an embedding layer 506 (e.g., a linear layer) is used for each modality to project the raw inputs from the trajectory data 402 into the embedding dimension. Additionally, an embedding for each timestep is learned and added to each token, with each timestep corresponding to three tokens.

The tokens are then processed by a decision transformer 510 (e.g., a causal transformer model), such as a generative AI model like a generative pre-trained (GPT) model, which uses autoregressive modeling to predict future actions. This means that, given a sequence of previous tokens (including states, actions, and returns-to-go), the decision transformer 510 predicts the next action in the sequence. The decision transformer 510 outputs the next action in the sequence as a predicted action embedding 512.

By way of example, in the context of the content delivery application 120 of the content delivery system 300, the embedding layer 506 receives a set of one or more entity trajectory features 502 from historical information stored for a set of one or more entities 302, such as a first entity 302 (E1), a second entity 302 (E2), and so forth. The embedding layer 506 converts the entity trajectory features 502 for the entities 302 into entity trajectory embeddings 508. For example, assume the trajectory data 402 comprises an entity trajectory features 502 that includes a sequence of content items represented as a tuple denoted as E1=[ci1, ci2, ci3, ci4, ci5], where ci denotes a content item identifier. Further assume the entity trajectory features 502 includes a sequence of actions denoted as Actions= [i1, i2, c3, i4, c5], where i represents an impression and c represents a click. Further assume the entity trajectory features 502 includes a sequence of revenue denoted as Revenue=[1, 1, 2, 1, 4]. Finally, assume a reward is defined as a tuple (C, I, R), where C represents a click to go, I represents an impression to go, and R represents a revenue to go. In this case, a reward tuple is denoted as Reward=(clicks, impressions, revenue). The embedding layer 506 receives the entity trajectory features 502 for an entity 302 and it generates an entity trajectory embedding 508 as follows: Input Transformer=[(ci1, impression, (2,2,8), (ci2, impression, (2,1,7)), (ci3, click, (1,1,5)), (ci4, impression, (1,0,4)), (ci5, click, (0,0,0))].

The decision transformer 510 receives as input the entity trajectory embedding 508 for the entity 302. The decision transformer 510 is a model that reframes reinforcement learning (RL) as a sequence modeling problem using transformers, which are models originally designed for natural language processing tasks. Instead of learning policies or value functions in a traditional RL sense, it treats sequences of states, actions, and rewards as data to predict the next action that will lead to a defined outcome.

By way of example, assume the objective is to lead an entity 302 to a conversion event using a series of content items 134 designed to provide increasing levels of information and interactions between the entity 302 and a business entity providing a product or service. The entity 302 may take actions such as view a content item (e.g., an impression), select a content item (e.g., a click), request more information (e.g., an email or chatbot), and other types of interactions. Rewards are assigned to each action to encourage a shorter path between learning about a product or service and purchasing a product or service, such as assigning a −1 or +1 for each action by the entity 302 along the path, and a reward of +10 for reaching the goal of a conversion event. A total reward is assigned that is set as a defined value aiming to reach the goal efficiently. For example, a marketing campaign might set a total reward value of +6 for a given conversion event. Embodiments are not limited to these examples.

Traditional RL uses policy learning where an agent learns a policy π(a|s) that tells it the best action a to take in each state s. It may estimate a value function V(s) or action-value function Q(s, a) to predict expected future rewards. Through trial and error, the agent explores the path from initial impression to conversion event, updating its policy based on the rewards received.

The decision transformer 510 takes a different route. First, the RL problem is formulated as a sequence modeling problem that predicts a next action in a sequence, given states, actions, rewards, and a desired future reward (return). The agent collects trajectories (sequences) of states, actions, and rewards from the environment. The agent models an input as a sequence of desired returns, states, and actions. The agent models an output as a next action to take in the sequence to achieve the defined outcome.

To train the decision transformer 510 for inferencing operations, a training device performs data collection to collect a training dataset of previous trajectories. For each timestep, the training device prepares the input sequences having a defined return which is a cumulative reward to be achieved from the current timestep onward, all states up to the current timestep, and all actions up to the current timestep. The training device trains the decision transformer 510 to predict a next action that will help achieve a target reward (e.g., the defined return). The training device uses a loss function for the training, such as a cross-entropy loss between the predicted action probabilities and the actual actions taken. Once trained, the decision transformer 510 performs inferencing operations at each timestep during deployment. For example, the decision transformer 510 starts with a maximum possible return (e.g., +10), receives as input the entity trajectory embedding 508 comprising the defined return, states, and actions, and it outputs the next action most likely to lead toward achieving the defined return. The decision transformer 510 then subtracts the received reward from the defined return for the next timestep. The decision transformer 510 repeats this process in an execution loop for each timestep, continuously updating the defined reward, states, and actions, and predicting the next action until the goal is reached. By learning from past trajectories, the decision transformer 510 predicts actions that are likely to achieve the defined cumulative reward, effectively planning ahead in a way similar to how language models predict the next word in a sentence.

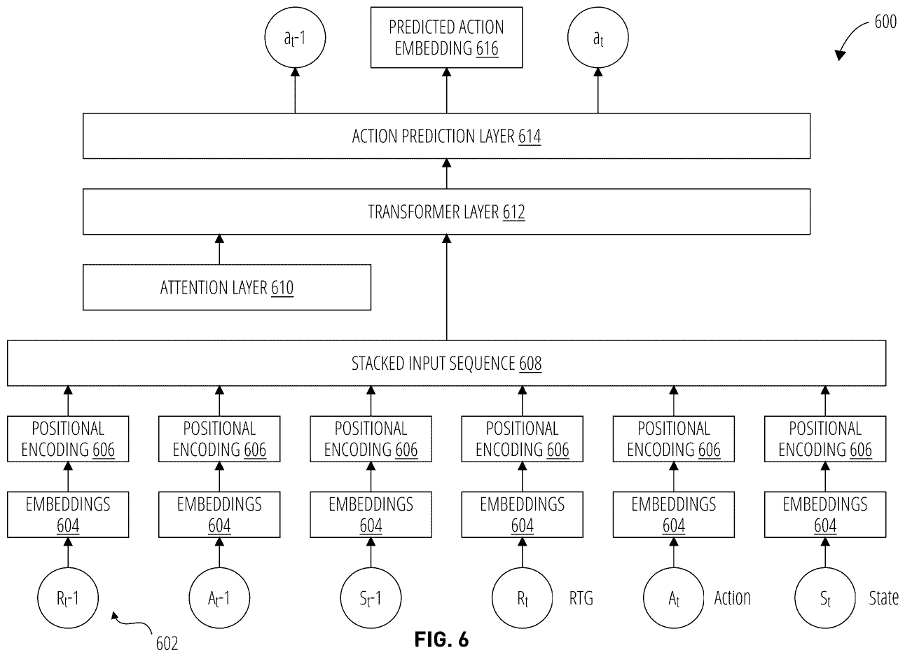

FIG. 6 illustrates an ML architecture 600. The ML architecture 600 is an example of an ML architecture or ML framework suitable for implementing the decision transformer 510 as described with reference to FIG. 5. Specifically, the ML architecture 600 depicts a set of states, actions and rewards being fed into modality-specific linear embeddings and a positional episodic timestep encoding is added. Tokens are fed into a GPT architecture which predicts actions autoregressively using a causal self-attention mask. Embodiments are not limited to this example.

As depicted in FIG. 6, the ML architecture 600 comprises an input layer 602 comprising tuples of rewards, actions, and states from interactions of an entity 302 with the user interface of the connection network platform 112 of the connection network system 100. These tuples are represented as a sequence of tokens, which are then embedded into continuous vectors as embeddings 604 using the embedding layer 506. Positional encodings 606 are added to the embeddings 604 (e.g., embedded input vectors) to capture the relative position of the input tokens. This allows the model to recognize the order of the input tokens and understand the temporal relationships between them. The result is a stacked input sequence 608. The stacked input sequence 608 is fed as input to a transformer layer 612.

The ML architecture 600 comprises an attention layer 610. The core of the transformer architecture is the multi-head self-attention mechanism. This layer computes attention scores for each input token, capturing the dependencies between different tokens in the input sequence. The self-attention mechanism is applied multiple times in parallel (multi-head) to learn different aspects of the input data. A feed-forward neural network is applied to each position independently after the multi-head self-attention layer. This component comprises two linear layers with an activation function (usually ReLU) in between, which helps the model learn more complex patterns within the input data.

The ML architecture 600 comprises a transformer layer 612. The transformer layer 612 receives as input the stacked input sequence 608 and the output from the attention layer 610. In each layer of the transformer layer 612, residual connections combine the outputs of the self-attention and feed-forward layers with their inputs. Layer normalization is then applied to stabilize the training process and improve the model's generalization capability. In some embodiments, the ML architecture 600 comprises multiple layers of self-attention and feed-forward components stacked on top of each other. This deep structure enables the model to learn complex hierarchical relationships within the input data.

The ML architecture 600 comprises an action prediction layer 614. The final layer of the decision transformer 510 is a linear layer that maps the continuous output vectors back to the action space, generating the predicted action sequence. The action prediction layer 614 outputs a predicted action embedding 616 with the next predicted action in the sequence.

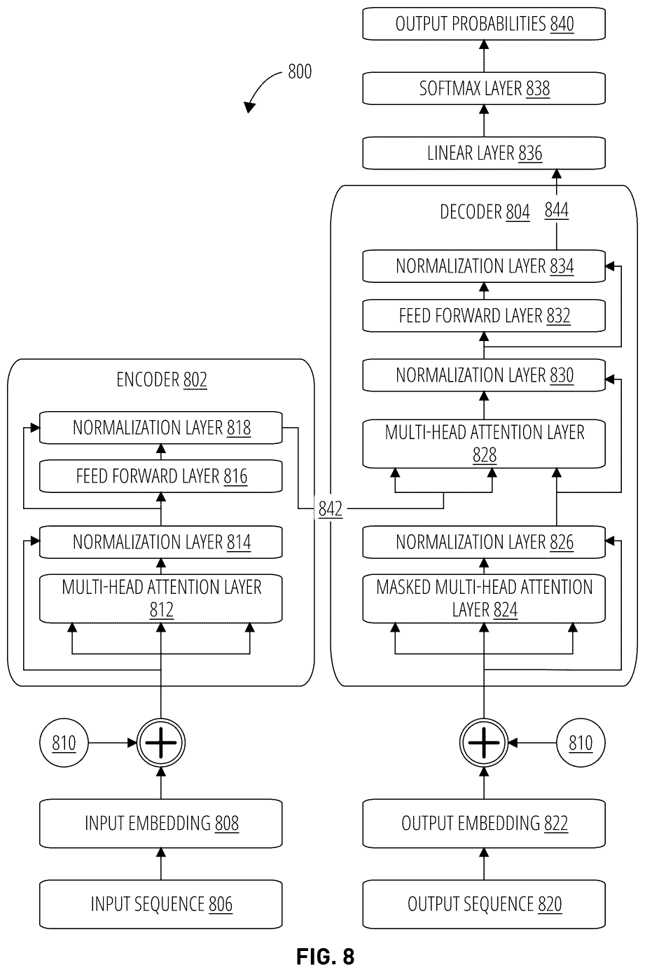

It is worthy to note that the decision transformer 510 does not explicitly include traditional reinforcement learning components such as value functions or policy gradients. Instead, it leverages the power of the transformer architecture to learn an effective policy for the given task by predicting future action sequences that maximize cumulative rewards. An example of a transformer architecture is further described with reference to FIG. 8.

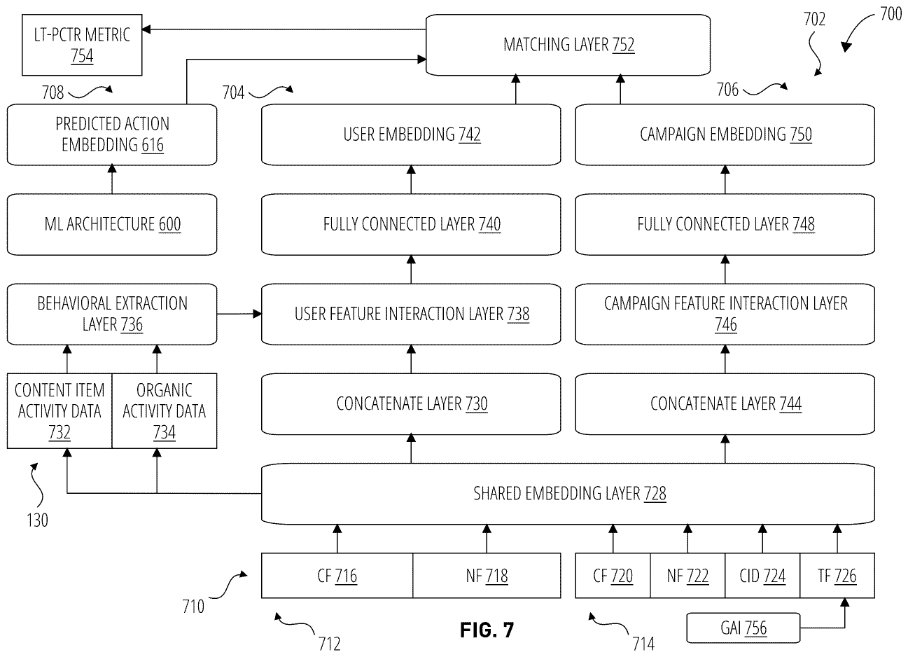

FIG. 7 illustrates an ML architecture 700. The ML architecture 700 is an example of a ML architecture or framework suitable for use as ML model 230 for the connection network platform 112 of the content delivery system 300. Specifically, the ML architecture 700 is an example of a ML architecture or framework for a multi-tower ML model 412. The multi-tower ML model 412 may output a metric 404, such as a pCTR and/or a LT-pCTR, suitable for use in various downstream tasks, such as selection of a next content item (e.g., advertisement 314) in a sequence of content items 134, selection of entities 302 for a PA segment of a content delivery campaign 308 suitable for delivery of advertisements 314 to electronic devices of the users 108 by the content delivery system 300, ranking content items 134, recommending content items 134, and other AI/ML related tasks for the connection network platform 112 of the connection network system 100. In one embodiment, for example, the ML model 230 is an EBR model. Embodiments are not limited to this example.

As depicted in FIG. 7, the ML architecture 700 illustrates an example of a multi-tower ML model 702, such as multi-tower ML model 412 described with reference to FIG. 4, that receives as input an input vector 710, analyzes the input vector 710, and it generates a metric 404 such as an LT-pCTR metric 754. The multi-tower ML model 702 comprises a first tower 704, a second tower 706, and a third tower 708. The first tower 704 is designed to process a first vector 712 of an input vector 710 to generate a user embedding 742. The second tower 706 is designed to process a second vector 714 of the input vector 710 to generate a campaign embedding 750. The third tower 708 is designed to process the entity trajectory features 502 for the entities 302 to generate predicted action embeddings 616. A matching layer 752 generates similarity scores for the user embedding 742, the campaign embedding 750, and the predicted action embedding 616 using a similarity measure, such as cosine similarity. The matching layer 752 ranks and outputs an LT-pCTR metric 754 for an entity 302 based on the similarity measure.

In a particular embodiment, the multi-tower ML model 702 receives an input vector 710 comprising a first vector 712 and a second vector 714 by a multi-tower ML model 702 for a content delivery system 300 of a connection network system 100. The first vector 712 comprises user features representing user attributes and activity data 130 associated with users 108 of the connection network system 100. The second vector 714 comprises campaign features representing a content delivery campaign 308. The campaign features may include, among other campaign features, a textual description of a content delivery campaign 308 managed by the content delivery system 300, denoted as textual features 726 of the second vector 714.

The multi-tower ML model 702 generates multiple embeddings from the input vector 710. The multi-tower ML model 702 generates a set of one or more user embeddings 742 from the first vector 712 by a first tower 704 of the multi-tower ML model 702 based on the activity data 130 associated with users 108 of the connection network system 100. The activity data 130 represents content item activity data 732 and organic activity data 734. The multi-tower ML model 702 also generates a set of one or more campaign embeddings 750 from the second vector 714 of the input vector 710 by a second tower 706 of the multi-tower ML model 702 based on, at least in part, the textual description of the content delivery campaign 308. The multi-tower ML model 702 also generates a set of one or more predicted action embeddings 616 from the entity trajectory features 502. A matching layer 752 of the multi-tower ML model 702 generates a predicted click-through-rate (pCTR) metric, such as LT-pCTR metric 754, based on a subset of the user embeddings 742, a subset of the campaign embeddings 750, and/or a subset of predicted action embeddings 616.

More particularly, a shared embedding layer 728 of the multi-tower ML model 702 receives as input an input vector 710. An input vector in a machine learning model is a structured array of data that represents a single instance or observation. Each element in this vector corresponds to a particular feature or attribute of the instance, collectively providing a complete description that the model can process. The features can be numerical, categorical (often encoded into numerical form), or even binary, depending on the nature of the data and model requirements. Before being used in the model, these vectors typically undergo preprocessing steps like normalization or encoding to ensure they are in a suitable format. The structure of the input vector must align with what the model expects, as mismatches can lead to errors or suboptimal performance. In practice, multiple input vectors are often processed together in batches for efficiency, especially in models like neural networks. For example, in a model predicting house prices, an input vector might include data such as square footage, the number of bedrooms, and the age of the house, which the model then uses to make its prediction.

The input vector 710 comprises two parts denoted as a first vector 712 and a second vector 714. The first vector 712 comprises data for user-side features (or member-side features) such as categorical features 716 and numerical features 718 representing user-side features for a user 108, such as entity data 128 and activity data 130 for the user 108. The second vector 714 comprises campaign-side features, such as categorical features 720, numerical features 722, a campaign ID 724, and textual features 726.

In one embodiment, for example, the textual features 726 for the second vector 714 are generated by a separate ML model 230, such as a generative AI (GAI) model denoted as GAI 756. The GAI 756 is designed to create new data samples that resemble a given dataset. Non-limiting examples of GAI 756 include generative adversarial networks (GANs), variational autoencoders (VAEs), transformers in Natural Language Processing (NLP) such as large language models (LLM) like generative pre-trained transformer (GPT) designed to generate human-like text based on a given prompt, diffusion models, autoregressive models, and so forth. In various embodiments, for example, the GAI 756 may be implemented as a transformer model such as a large language model (LLM) like a Bidirectional Encoder Representations from Transformers (BERT) model, Lightweight BERT (LIBERT) model, or a Lightweight Decoding-Enhanced BERT with Disentangled Attention (LiDeBERT) model. The GAI 756 is feed as input information about a content delivery campaign 308, such as one or more campaign attributes 310, and it performs creative content generation with a description for the content delivery campaign 308 in text form. The textual features 726 are derived from the output of the GAI 756.

The input vector 710 is fed into a shared embedding layer 728. An embedding layer in a neural network is a technique used to convert categorical data, such as words or items, into continuous vectors in a lower-dimensional space. This layer is particularly common in natural language processing (NLP) tasks, where it transforms words into dense vectors that capture semantic relationships between them. The embedding layer learns these representations during training, allowing the model to understand and work with complex, high-dimensional categorical data in a more efficient and meaningful way. This approach improves a model's ability to capture similarities and relationships within the data, leading to better performance on tasks like text classification, translation, and sentiment analysis. The shared embedding layer 728 is used in the multi-tower ML model 702 to create a common representation for the first vector 712 and the second vector 714 of the input vector 710 that share similar characteristics, such as words or entities, across different contexts. By using the same embedding layer for multiple inputs, the multi-tower ML model 702 can learn consistent and meaningful representations that capture relationships across the different inputs, regardless of their specific context. This approach is particularly useful in tasks like multi-modal learning or when working with multiple sequences that need to be understood in a unified way, enabling the model to generalize better and reduce the need for redundant parameters.

The first tower 704 receives as input a shared embedding that is output from the shared embedding layer 728. A concatenate layer 730 of the first tower 704 concatenates shared embeddings, and it outputs a concatenated embedding. In addition, the shared embedding is input to a behavioral extraction layer 736. The behavioral extraction layer 736 extracts behavioral pattern features from content item activity data 732 and organic activity data 734 from the shared embedding. The content item activity data 732 represents interactions between an entity identifier for a user 108 and a content item of the content items 134 from the content delivery campaign 308. Non-limiting examples of content items 134 may comprise online advertisements from a sequential or non-sequential list of advertisements associated with a content delivery campaign 308. The organic activity data 734 may represent natural activities of a user 108, such as interactions between a user 108 and various organic content presented on a website of the connection network platform 112, such as products and/or services offered by the connection network platform 112 of the connection network system 100. Non-limiting examples of organic content include infrastructure elements or supporting elements that enable or support the delivery of content but are not considered content (e.g., backend code, database structures, metadata, etc.), functional elements or structural components that contribute to website functionality or layout (e.g., navigation menus, footers, buttons, sidebars, forms, etc.), GUI elements that include all the interactive and design aspects that help users interact with content items, or user generated content. Non-limiting examples of user generated content may include professional profiles with detailed information about users of the connection network system (e.g., work experience, skills, and endorsements), articles or posts created by users and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where users can share ideas and discuss industry trends, and other types of content designed to facilitate professional growth and industry engagement. Embodiments are not limited to these examples.

The behavioral extraction layer 736 is a specialized component that captures and analyzes user behavior to infer preferences and interests. The behavioral extraction layer 736 uses data from both content item activity data 732 such as advertising activities (e.g., clicks on ads, engagement with promoted content, etc.) and organic activity data 734 such as organic activities of a user 108 interacting with the connection network platform 112 (e.g., profile views, connections, post interactions, etc.) to build a comprehensive profile of user preferences. The content item activity data 732 includes any interaction a user 108 has with ads, such as clicks, time spent on ad content, conversions, etc. The organic activity data 734 includes organic activities such as non-ad-based activities like viewing job postings, interacting with professional content, sending messages, making connections, and profile updates. The behavioral extraction layer 736 extracts features from both types of activities, such as frequency of interactions, types of content engaged with, keywords associated with the activities, and behavioral patterns over time. For example, if a user 108 frequently engages with ads related to data science and also organically interacts with content about AI research, the layer would capture this as a preference for data science and AI. The behavioral extraction layer 736 analyzes these extracted features to infer user preferences or behavior. For instance, it might identify that a user is interested in career development if they engage with content about skill-building and frequently interact with ads promoting courses. This inference could involve techniques like clustering, classification, or neural networks to categorize user preferences. The behavioral preference behavioral extraction layer 736 integrates with the broader recommendation or personalization system within the connection network platform 112. This allows the platform to tailor content, job recommendations, and ads based on the inferred preferences, making the user experience more relevant. In some implementations, the system could incorporate a feedback loop, where the effectiveness of content and ad recommendations is monitored and used to refine the preference extraction process.

For example, assume a user 108 interacts with connection network platform 112 such as frequently clicking on ads for leadership courses and also engages with content related to team management. The behavioral preference behavioral extraction layer 736 would combine these signals to infer that the user 108 is interested in leadership development. Consequently, the content delivery system 300 might prioritize showing them related job opportunities, relevant content, and more targeted ads. The behavioral extraction layer 736 helps create a more personalized and relevant user experience by leveraging both advertising and organic activities to understand and predict user preferences more accurately.

A user feature interaction layer 738 receives as input behavioral pattern features from the behavioral extraction layer 736 and the concatenated embedding from the concatenate layer 730. The user feature interaction layer 738 encodes a set of user interaction features based on the behavioral pattern features and the concatenated embedding. The user feature interaction layer 738 is another specialized component that captures and models the interactions between various features related to a user activities, profile attributes, and engagement patterns. The goal of this layer is to better understand how different features or attributes of a user 108 interact with one another to influence outcomes such as content recommendations, job matches, or social connections. The user feature interaction layer 738 encodes various user-related data points (features) into a format suitable for machine learning. These features could include entity data 128 for a user 108 such as profile information (e.g., job title, industry, location), activity data 130 of the user 108 (e.g., likes, shares, comments, searches), and network data (e.g., connections, groups). The user feature interaction layer 738 models how different features interact with each other. For example, the user feature interaction layer 738 may determine a relationship between profile and activity interaction, such as a job title for a user 108 and a type of content items 134 with which the user 108 interacts. The user feature interaction layer 738 may determine a relationship between network and engagement interaction, such as a size or composition of a user's network impact a user 108 engagement with content. The user feature interaction layer 738 may determine a relationship between demographics and behavior interaction, such as how do demographic factors like location or industry interact with behavioral data like search history or content sharing. The user feature interaction layer 738 may create cross-feature terms or use advanced techniques like factorization machines or neural networks to capture non-linear interactions between features. Since interactions can exponentially increase the number of features, the user feature interaction layer 738 often includes techniques to reduce dimensionality while preserving important interactions. For example, the user feature interaction layer 738 may implement Principal Component Analysis (PCA) or embedding layers in neural networks.

For example, assume a user 108 is a software engineer with a history of engaging with AI-related content and is connected to a significant number of AI professionals. The user feature interaction layer 738 would model the interaction between their job title, content engagement, and network connections to better understand their professional focus. This insight could then be used to recommend relevant job postings in AI, suggest connections with key AI influencers, or surface related articles and courses. In this way, the user feature interaction layer 738 enhances the ability to make personalized and relevant predictions by capturing the nuanced relationships between various user attributes and activities.

A fully connected layer 740 receives as input the user interaction features, and it generating the user embedding 742 based on the user interaction features. The fully connected layer 740 generates a user embedding 742 for the set of user embeddings 742 based on the user interaction features identified by the user feature interaction layer 738. The fully connected layer 740 comprises a set of neurons using an activation function, such as a hyperbolic tangent (tanh), for example. More particularly, the fully connected layer 740 in the first tower 704 is a specialized component that connects every neuron from a previous layer to every neuron in a current layer. When used to generate a user embedding 742, this layer takes a high-dimensional input, such as user interaction features describing a user's profile, activity, and preferences, and transforms it into a lower-dimensional vector that encapsulates the user's key characteristics. This embedding serves as a condensed representation of the user 108, capturing the essential patterns and relationships between different features in a way that the model can use for tasks like recommendations, personalization, or predictions. By learning these embeddings through training, the neural network can effectively encode complex entity data 128 and activity data 130 into meaningful and compact vectors that can be leveraged across various applications within the system.

Similar to the first tower 704 of the multi-tower ML model 702, the second tower 706 also includes a concatenate layer 744 and a fully connected layer 748. The concatenate layer 744 and the fully connected layer 748 of the second tower 706 operate in a same or similar manner as described for the concatenate layer 730 and the fully connected layer 740 of the first tower 704. In addition, the second tower 706 comprise a campaign feature interaction layer 746. The user feature interaction layer 738 models user behavioral patterns based on entity data 128 and activity data 130, such as content item activity data 732 and organic activity data 734, to infer user interaction features. Similarly, the campaign feature interaction layer 746 models campaign patterns based on campaign attributes 310 and activity data 130 representing interactions between users 108 and content items 134 such as advertisement 314 delivered by a content delivery campaign 308. The concatenate layer 744, the campaign feature interaction layer 746, and the fully connected layer 748 of the second tower 706 represent the processing stages for generating a campaign embedding 750 for a set of campaign embeddings 750 for a given content delivery campaign 308.

As described with reference to FIG. 4, FIG. 5, and FIG. 6, the third tower 708 comprises an ML architecture 600 for a decision transformer 510. The decision transformer 510 operates as described with reference to FIG. 5 and FIG. 6.

A matching layer 752 receives as input the user embedding 742, the campaign embedding 750, and the predicted action embedding 616 from the first tower 704, the second tower 706, and the third tower 708, respectively, and it performs a matching function to match the user embedding 742 and the campaign embedding 750 and the predicted action embedding 616 to determine an LT-pCTR metric 754 for a user 108. At inference time, matching layer 752 compares the fine-tuned user embedding 742 and the fine-tuned campaign embedding 750 and the fine-tuned predicted action embedding 616 to produce a predicted probability of the corresponding user interacting with the corresponding piece of content. This comparison may, in some example embodiments, involve performing a geometric measurement of the distance between the embeddings in the latent n-dimensional space, such as by using a cosine distance calculation.

The matching layer 752 matches one or more user embeddings 742 with one or more campaign embeddings 750 and/or predicted action embeddings 616 using a similarity measure to form a set of matched embeddings, and it generates an LT-pCTR metric 754 based on the matched embeddings. A matching function in machine learning is designed to compare embeddings, which are compact, vectorized representations of data points, using a similarity measure. The purpose of this function is to assess how closely two embeddings align with one another, typically in tasks like recommendation, search, or classification. Common similarity measures include cosine similarity, Euclidean distance, or dot product, which quantify the degree of resemblance between the vectors. The matching function then uses this measure to determine the best match between embeddings, effectively linking similar items, users, or features based on their underlying patterns as captured by the embeddings. The matching layer 752 uses a similarity measure, such as cosine similarity, to quantify a degree of resemblance between the user embedding 742 of an entity 302, the campaign embedding 750 of a content delivery campaign 308, and the predicted action embedding 616 from the decision transformer 510. A higher degree of similarity indicates a higher probability that the user 108 would be interested in advertisements 314 associated with the content delivery campaign 308 and delivered by the content delivery system 300 to obtain a defined outcome, such as a conversion event.

The multi-tower ML model 702 may be trained by a training device on a training dataset of training datapoints. Once trained, the multi-tower ML model 702 may perform inferencing operations on new datapoints to support the content delivery application 120 of the content delivery system 300. In one embodiment, for example, the multi-tower ML model 702 may be trained using a training dataset comprising one or more training datapoints. For example, the training datapoints may comprise pseudo-labels derived from click actions on a web page, such as a landing page, of a GUI 136 of the connection network platform 112 of the connection network system 100. In another example, the training datapoints may comprise chargeable clicks on a web page of a GUI 136 of the connection network platform 112 of the connection network system 100. Embodiments are not limited to these examples. A training device and training operations for the multi-tower ML model 702 are described in more detail with reference to FIG. 9.

FIG. 8 illustrates a transformer model 800. The transformer model 800 is an example of a transformer architecture suitable for use by the GAI 756 of the multi-tower ML model 702 of the ML architecture 700. In particular, the transformer model 800 is an example of a transformer architecture suitable for GPT, such as a version of ChatGPT. ChatGPT is trained on massive amounts of data, allowing it to generate text and respond to various prompts with human-like precision and accuracy. Embodiments are not limited to transformers.

As depicted in FIG. 8, the transformer model 800 comprises an encoder 802 and a decoder 804. The encoder 802 receives as input an input sequence 806, which is converted to an input embedding 808. A positional encoding 810 is added to the input embedding 808. The input embedding 808 with positional encoding 810 is input to the encoder 802. The encoder 802 comprises a multi-head attention layer 812, a normalization layer 814, a feed forward layer 816, and a normalization layer 818. The encoder 802 outputs an encoder output 842 to the decoder 804. The decoder 804 receives as input an output sequence 820, which is converted to an output embedding 822. A positional encoding 810 is added to the output embedding 822. The output embedding 822 with positional encoding 810 is input to the decoder 804. The decoder 804 comprises a masked multi-head attention layer 824, a normalization layer 826, a multi-head attention layer 828, a normalization layer 830, a feed forward layer 832, and a normalization layer 834.

Specifically, the encoder 802 is a neural sequence transduction model comprising an encoder 802 and a decoder 804. The encoder 802 receives an input sequence 806 and it translates the input sequence 806 into a lower-dimensional space. The encoder 802 maps an input sequence of symbol representations (x₁, . . . , xₙ) to a sequence of continuous representations z=(z₁, . . . , Zₙ). Given z, the decoder 804 then generates an output sequence (y₁, . . . , yₘ) of symbols one element at a time. At each step, the model is auto-regressive, consuming the previously generated symbols as additional input when generating the next. The decoder 804 translates the lower-dimensional data provided by the encoder 802 back to the original data format. Both the encoder 802 and the decoder 804 share three main types of layers, including a positional encoding layer, self-attention layer, and feedforward layer.

The encoder 802 transforms natural language input into numerical vectors. The encoder 802 receives an input sequence 806. The input sequence is a sequence of tokens (e.g., words or sub-words) that represent the text input. An input encoding layer of the encoder 802 converts the input sequence 806 into an input embedding 808. An input embedding 808 is a numerical representation of concepts converted to number sequences. The input embedding 808 is an NLP technique that represents words with vectors in such a way that once represented in a vectorial space, the mathematical distance between vectors is representative of the similarity among words they represent. For example, the content delivery application 120 may incorporate input embeddings to personalize, recommend, and search content. The input embedding 808 may comprise a matrix of vectors, where each vector represents a token in the sequence. The input embedding layer maps each token to a high-dimensional vector that captures the semantic meaning of the token.

Positional encoding 810 is a fixed, learned vector that represents a position of a word in the input sequence. It is added to the input embedding 808 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 808. The positional encoding is a vector that represents the position of each token in the sequence.

The encoder 802 includes multiple self-attention layers. The self-attention layers are responsible for determining the importance of each input token in generating the output. The self-attention layer allows the model to compute relationships between different parts of the input sequence 806. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 802 uses a multi-head attention layer 812. The multi-head attention layer 812 uses multiple self-attention layers operating in parallel on different parts of the input data, producing multiple representations. The multi-head attention layer 812 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 816.

The feed forward layer 816 comprises a series of fully connected layers and activation functions. The feed forward layer 816 transforms the output of the multi-head attention layer 812 into a suitable representation for the final output. The feed forward layer 816 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a ReLu. The output of the feed forward layer 816 is used as input to the next layer in the encoder 802.

The encoder 802 may also comprise a number of normalization layers, such as a normalization layer 814 and a normalization layer 818. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 818 is the final output from the encoder 802 and it is a vector representation of the input sequence 806. The final output from the normalization layer 818 is used as input to the multi-head attention layer 828 of the decoder 804.

The decoder 804 decodes the input sequence 806 to the original data format. Similar to the encoder 802, the decoder 804 shares the core elements of positional encoding, self-attention, and feedforward layers. As depicted in transformer model 800, the decoder 804 comprises a masked multi-head attention layer 824, a normalization layer 826, a multi-head attention layer 828, a normalization layer 830, a feed forward layer 832, and a normalization layer 834. The decoder 804 outputs a decoder output 844 to a linear layer 836. The linear layer 836 is a feedforward network that adapts the dimension of the input to the dimension of the output. The output of the linear layer 836 feeds into a softmax layer 838. The softmax layer 838 transforms the input into a vector of probabilities. The output of the softmax layer 838 is a set of an output probabilities 840 for the transformer model 800. The transformer model 800 then picks the word corresponding to the highest probability and uses it as a best output of the model.

In some embodiments, the transformer layer 612 of the ML architecture 600 for the decision transformer 510 may use some or all parts of the transformer model 800 depending on a given implementation. Embodiments are not limited to the example given for transformer model 800.

FIG. 9 illustrates an apparatus 900. The apparatus 900 depicts a training device 902 suitable for training an ML model 920 for the connection network system 100. Specifically, the training device 902 trains the ML model 920 to perform inferencing operations in support of the content delivery application 120, ranking model 122, or recommendation model 124.

As depicted in FIG. 9, the training device 902 includes a processing circuitry 904 and a memory unit 906. The memory unit 906 may store a set of ML components 908 to support various AI/ML techniques. The ML components 908 comprise a data collector 910, a model trainer 912, a model evaluator 914 and a model inferencer 916.

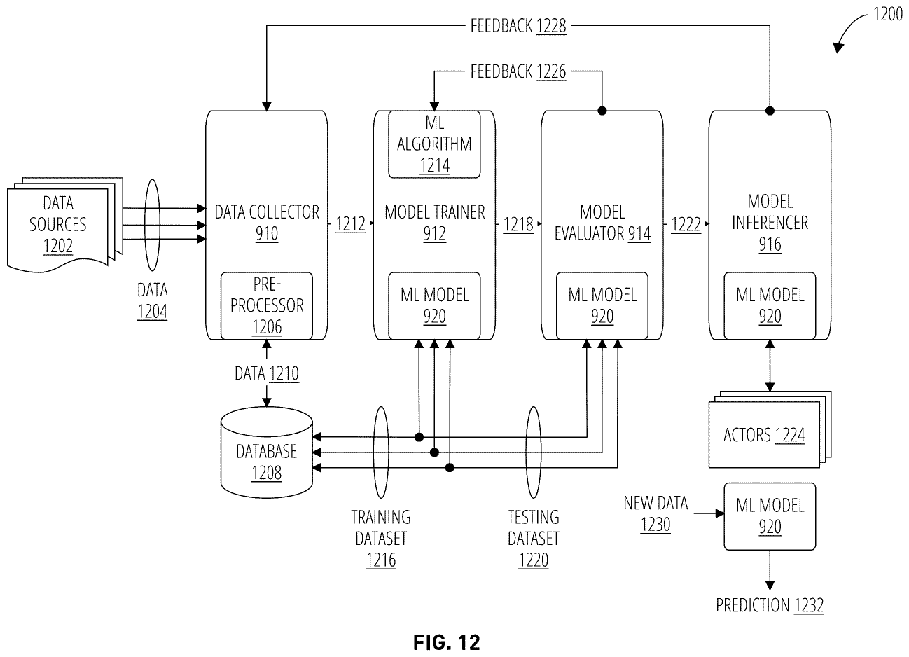

In general, the data collector 910 collects data 918 from one or more data sources to use as training data for an ML model 920. The data collector 910 collects different types of data 918, such as text information, audio information, image information, video information, graphic information, and so forth. The model trainer 912 receives as input the collected data and uses a portion of the collected data as test data for an AI/ML algorithm to train the ML model 920. The model evaluator 914 evaluates and improves the trained ML model 920 using a portion of the collected data as test data to test the ML model 920. The model evaluator 914 also uses feedback information from the deployed ML model 920. The model inferencer 916 implements the trained ML model 920 to receive as input new unseen data, generate one or more inferences on the new data, and output a result such as an alert, a recommendation or other post-solution activity. An exemplary AI/ML architecture for the ML components 908 is described in more detail with reference to FIG. 12.

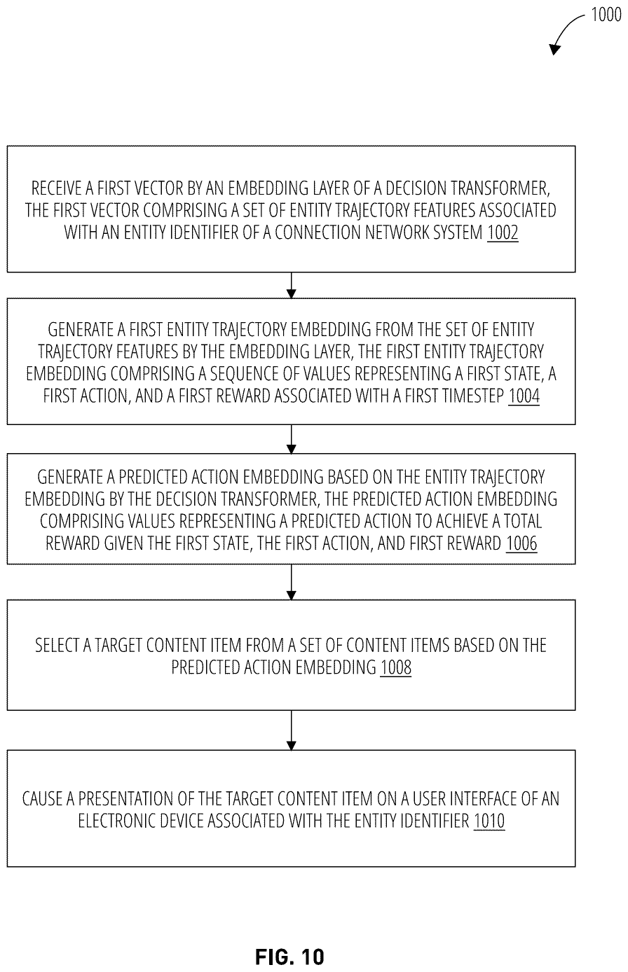

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the connection network platform 112 of the connection network system 100, such as the server device 102 and/or the client device 104. More particularly, the logic flow 1000 illustrates an example where the server device 102 performs a set of training and/or inferencing operations of a ML model such as an ML model 230 to support one or more network services 146 provided by the connection network platform 112 of the connection network system 100. For example, the logic flow 1000 may be performed by the server device 102 and/or the client device 104 using a system 200, content delivery system 300, logic diagram 400, ML architecture 500, ML architecture 600, ML architecture 700, transformer model 800, and/or apparatus 900.

As depicted in logic flow 1000, at block 1002 the logic flow 1000 includes receiving a first vector by an embedding layer of a decision transformer, the first vector comprising a set of entity trajectory features associated with an entity identifier of a connection network system. At block 1004, the logic flow 1000 includes generating a first entity trajectory embedding from the set of entity trajectory features by the embedding layer, the first entity trajectory embedding comprising a sequence of values representing a first state, a first action, and a first reward associated with a first timestep. At block 1006, the logic flow 1000 includes generating a predicted action embedding based on the entity trajectory embedding by the decision transformer, the predicted action embedding comprising values representing a predicted action to achieve a total reward given the first state, the first action, and first reward. At block 1008, the logic flow 1000 includes selecting a target content item from a set of content items based on the predicted action embedding. At block 1010, the logic flow 1000 includes causing a presentation of the target content item on a user interface of an electronic device associated with the entity identifier

By way of example, with reference to FIG. 5 and FIG. 6, the embedding layer 506 receives a first vector comprising a set of entity trajectory features 502 associated with an entity identifier of a connection network system 100. The embedding layer 506 generates a first entity trajectory embedding 508 from the set of entity trajectory features 502. The first entity trajectory embedding 508 comprises a sequence of values representing a first state, a first action, and a first reward associated with a first timestep. The decision transformer 510 receives the first entity trajectory embedding 508, and it generates a predicted action embedding 512 based on the first entity trajectory embedding 508. The predicted action embedding 512 comprises a set of one or more values representing a predicted action to achieve a total reward given the first state, the first action, and first reward of the first entity trajectory embedding 508. The content delivery application 120 of the content delivery system 300 selects a target content item from a set of content items 134 based on the predicted action embedding 512. The content delivery application 120 causes a presentation of the target content item on a user interface of an electronic device associated with the entity identifier, such as client device 104.

In some embodiments, for example, the first state comprises a content item from the set of content items, the first action comprises an impression or a click of the content item, and the first reward comprises a reward tuple of clicks, impressions, and rewards associated with the entity identifier and a content delivery campaign.

In some embodiments, for example, a matching layer 752 of the multi-tower ML model 702 receives multiple inputs from a first tower 704, a second tower 706, and a third tower 708. For instance, the first tower 704 outputs a user embedding 742 as input to the matching layer 752, the second tower 706 outputs a user embedding 742 as input to the matching layer 752, and the third tower 708 outputs a predicted action embedding 616 as input to the matching layer 752. The user embedding 742 comprises values representing user data and activity data associated with the entity identifier. The campaign embedding 750 comprises values representing campaign data for the content delivery campaign 308. The predicted action embedding 512 comprises a set of one or more values representing a predicted action to achieve a total reward given the first state, the first action, and first reward of the first entity trajectory embedding 508. The matching layer 752 generates a metric based on the predicted action embedding 512, the user embedding 742, and the campaign embedding 750, such as a shorter term metric such as a pCTR metric and/or a longer term metric such as an LT-pCTR metric 754.

In some embodiments, for example, a training device 902 collects a training dataset comprising multiple training datapoints, wherein a training datapoint comprises entity trajectory embeddings 508 associated with an entity identifier of the connection network system 100. The training device 902 trains the decision transformer 510 using the training dataset in an offline mode.

In some embodiments, for example, the matching layer 752 matches the predicted action embedding 512, the user embedding 742 and the campaign embedding 750 using a similarity measure to form a matched embedding, and it generates the pCTR and/or LT-pCTR metric 754 based on the matched embedding.

In some embodiments, for example, the metric comprises a first value representing a probability of an interaction between the entity identifier and the target content item associated with the content delivery campaign 308.

In some embodiments, for example, the metric comprises a second value representing a reward tuple of clicks, impressions, and rewards associated with the entity identifier and a content delivery campaign 308.

In some embodiments, for example, the first state comprises a content item from the set of content items 134, the content item comprising an electronic image, an animation, a video, or text information.

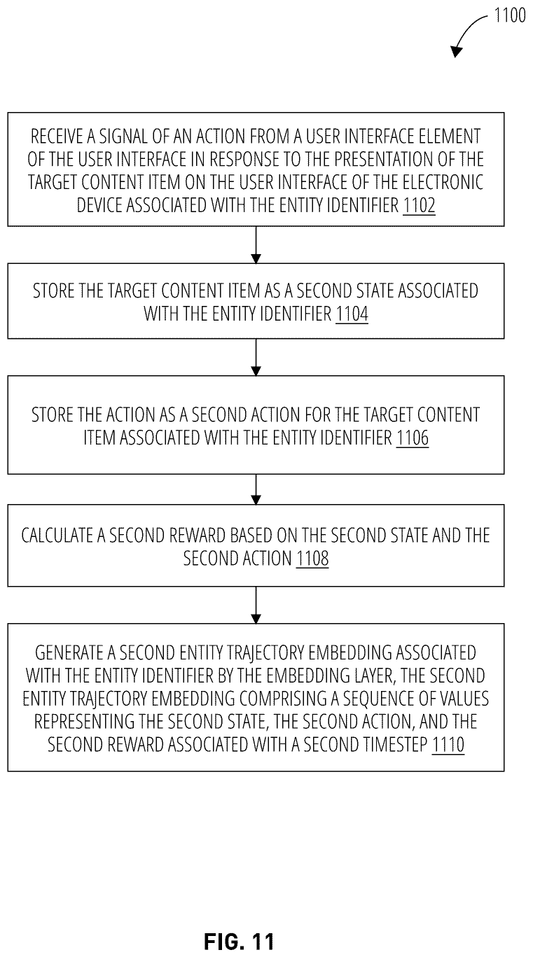

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the connection network platform 112 of the connection network system 100, such as the server device 102 and/or the client device 104. More particularly, the logic flow 1000 illustrates an example where the server device 102 performs a set of inferencing operations of a ML model such as a generative AI model to support one or more network services 146 provided by the connection network platform 112 of the connection network system 100. For example, the logic flow 1100 may be performed by the server device 102 and/or the client device 104 using a system 200, content delivery system 300, logic diagram 400, ML architecture 500, ML architecture 600, ML architecture 700, transformer model 800, and/or apparatus 900.

As depicted in logic flow 1100, at block 1102 the logic flow 1100 includes receiving a signal of an action from a user interface element of the user interface in response to the presentation of the target content item on the user interface of the electronic device associated with the entity identifier. At block 1102 the logic flow 1100 includes storing the target content item as a second state associated with the entity identifier. At block 1102 the logic flow 1100 includes storing the action as a second action for the target content item associated with the entity identifier. At block 1102 the logic flow 1100 includes calculating a second reward based on the second state and the second action. At block 1102 the logic flow 1100 includes generating a second entity trajectory embedding associated with the entity identifier by the embedding layer, the second entity trajectory embedding comprising a sequence of values representing the second state, the second action, and the second reward associated with a second timestep.

As previously described, the connection network platform 112 and/or the client application 110 and/or an operating system of the client device 104 may generate a GUI 136 on an electronic display of the client device 104. The client application 110 may receive one or more content items 134 from the data store 126 of the connection network platform 112 from the content delivery application 120. The client application 110 may display the content items 134 as content item 140 on a content feed 138 of the GUI 136. The content item 140 may include a user interface element 142 that when selected or activated by the user 108, causes the GUI 136 to generate a signal such as a message for delivery to the content delivery application 120 of the connection network platform 112. The signal or message may comprise a feedback signal to the content delivery application 120 for use by the content delivery application 120 to select a new content item from the data store 126 for delivery to the client device 104. For example, the content delivery application 120 may use the feedback signal as part of an ML model to select content items 134 for a marketing campaign managed by the content delivery application 120, as described in more detail with reference to FIG. 3

The content delivery application 120 receives a signal of an action from a user interface element 142 of the GUI 136 in response to the presentation of the target content item 140 on the GUI 136 of the client device 104 associated with the entity identifier. The content delivery application 120 stores the target content item 140 as a second state associated with the entity identifier and it stores the action as a second action for the target content item 140 associated with the entity identifier. The third ML model 410, such as a decision transformer 510 of the ML architecture 500 and/or ML architecture 600, calculates a second reward based on the second state and the second action, and it generates a second entity trajectory embedding 508 associated with the entity identifier by the embedding layer 506. The second entity trajectory embedding 508 comprises a sequence of values representing the second state, the second action, and the second reward associated with a second timestep. This process continues until a target reward is obtained, such as a conversion event for the content delivery campaign 308 managed by the content delivery system 300.

FIG. 12 illustrates a logic diagram 1200 suitable for use by the training device 902 to generate the ML model 920 for deployment by an inferencing device of the connection network platform 112. The logic diagram 1200 is an example of a system suitable for implementing various AI techniques and/or ML techniques to perform various training tasks on behalf of the various devices of the connection network system 100.

In one embodiment, the training device 902 trains an ML model 920. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 902 may pretrain an ML model 920 before training the ML model 920 or trains a pretrained ML model 920. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 1200 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 920, evaluate performance of the trained ML model 920, and deploy the tested ML model 920 as the trained ML model 920 in a production environment, and continuously monitor and maintain it.

The ML model 920 is a mathematical construct used to predict outcomes based on a set of input data. The ML model 920 is trained using large volumes of training dataset 1216, and it can recognize patterns and trends in the training dataset 1216 to make accurate predictions. The ML model 920 is derived from an ML algorithm 1214. A data set is fed into the ML algorithm 1214 which trains an ML model 920 to “learn” a function that produces mappings between a set of inputs and a set of outputs with a reasonably high accuracy. Given a sufficiently large enough set of inputs and outputs, the ML algorithm 1214 finds the function for a given task. This function may even be able to produce the correct output for input that it has not seen during training. A data scientist prepares the mappings, selects and tunes the ML algorithm 1214, and evaluates the resulting model performance. Once the ML model 920 is sufficiently accurate on test data, it can be deployed for production use.

The ML algorithm 1214 is generally a computational procedure used to identify patterns within data and make inferences or predictions without being explicitly programmed for every scenario. The ML algorithm 1214 can process input data, learn from it by adjusting internal parameters, and then apply the learned information to new, unseen data. The ML algorithm 1214 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1214 of the logic diagram 1200 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 12, the logic diagram 1200 includes a set of data sources 1202 to source data 1204 for the training device 902. Data sources 1202 may comprise any device capable generating, processing, storing or managing data 1204 suitable for a ML system. Examples of data sources 1202 include without limitation databases, web scraping, sensors and Internet of Things (IoT) devices, image and video cameras, audio devices, text generators, publicly available databases, private databases, and many other data sources 1202. The data sources 1202 may be remote from the training device 902 and accessed via a network, local to the training device 902 and accessed via a network interface, or may be a combination of local and remote data sources 1202.

The data sources 1202 source difference types of data 1204. By way of example and not limitation, the data 1204 includes structured data from relational databases, such as customer profiles, transaction histories, or product inventories. The data 1204 includes unstructured data from websites such as customer reviews, news articles, social media posts, or product specifications. The data 1204 includes data from temperature sensors, motion detectors, and smart home appliances. The data 1204 includes image data from medical images, security footage, or satellite images. The data 1204 includes audio data from speech recognition, music recognition, or call centers. The data 1204 includes text data from emails, chat logs, customer feedback, news articles or social media posts. The data 1204 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1204 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1202 are communicatively coupled to a data collector 910. The data collector 910 gathers relevant data 1204 from the data sources 1202. Once collected, the data collector 910 may use a pre-processor 1206 to make the data 1204 suitable for analysis. This involves data cleaning, transformation, and feature engineering. Data preprocessing is a critical step in ML as it directly impacts the accuracy and effectiveness of the ML model 920. The pre-processor 1206 receives the data 1204 as input, processes the data 1204, and outputs pre-processed data 1210 for storage in a database 1208. Examples for the database 1208 includes a hard drive, solid state storage, and/or random access memory (RAM).

The data collector 910 is communicatively coupled to a model trainer 912. The model trainer 912 performs AI/ML model training, validation, and testing which may generate model performance metrics as part of the model testing procedure. The model trainer 912 receives the pre-processed data 1210 as input 1212 or via the database 1208. The model trainer 912 implements a suitable ML algorithm 1214 to train an ML model 230 on a set of training dataset 1216 from the pre-processed data 1210. The training process involves feeding the pre-processed data 1210 into the ML algorithm 1214 to produce or optimize an ML model 920. The training process adjusts its parameters until it achieves an initial level of satisfactory performance.

The model trainer 912 is communicatively coupled to a model evaluator 914. After an ML model 920 is trained, the ML model 920 needs to be evaluated to assess its performance. This is done using various metrics such as accuracy, precision, recall, and F1 score. The model trainer 912 outputs the ML model 920, which is received as input 1212 or from the database 1208. The model evaluator 914 receives the ML model 230 as input 1218, and it initiates an evaluation process to measure performance of the ML model 920. The evaluation process includes providing feedback 1226 to the model trainer 912. The model trainer 912 re-trains the ML model 920 to improve performance in an iterative manner.

The model evaluator 914 is communicatively coupled to a model inferencer 916. The model inferencer 916 provides AI/ML model inference output (e.g., inferences, predictions or decisions). Once the ML model 920 is trained and evaluated, it is deployed in a production environment where it is used to make predictions on new data. The model inferencer 916 receives the evaluated ML model 920 as input 1222. The model inferencer 916 uses the evaluated ML model 920 to produce insights or predictions on real data, which is deployed as a final production ML model 920. The inference output of the ML model 920 is use case specific. The model inferencer 916 also performs model monitoring and maintenance, which involves continuously monitoring performance of the ML model 920 in the production environment and making any necessary updates or modifications to maintain its accuracy and effectiveness. The model inferencer 916 provides feedback 1226 to the data collector 910 to train or re-train the ML model 920. The feedback 1226 includes model performance feedback information, which is used for monitoring and improving performance of the ML model 920.

Some or all of the model inferencer 916 is implemented by various actors 1224 in the logic diagram 1200, including the ML model 920 of the connection network platform 112, for example. The actors 1224 use the deployed ML model 920 on new data to make inferences or predictions for a given task, and output a prediction 1232. The actors 1224 implement the model inferencer 916 locally, or remotely receives outputs from the model inferencer 916 in a distributed computing manner. The actors 1224 trigger actions directed to other entities or to itself. The actors 1224 provide feedback 1228 to the data collector 910 via the model inferencer 916. The feedback 1228 comprise data needed to derive training data, inference data or to monitor the performance of the ML model 920 and its impact to the network through updating of key performance indicators (KPIs) and performance counters.

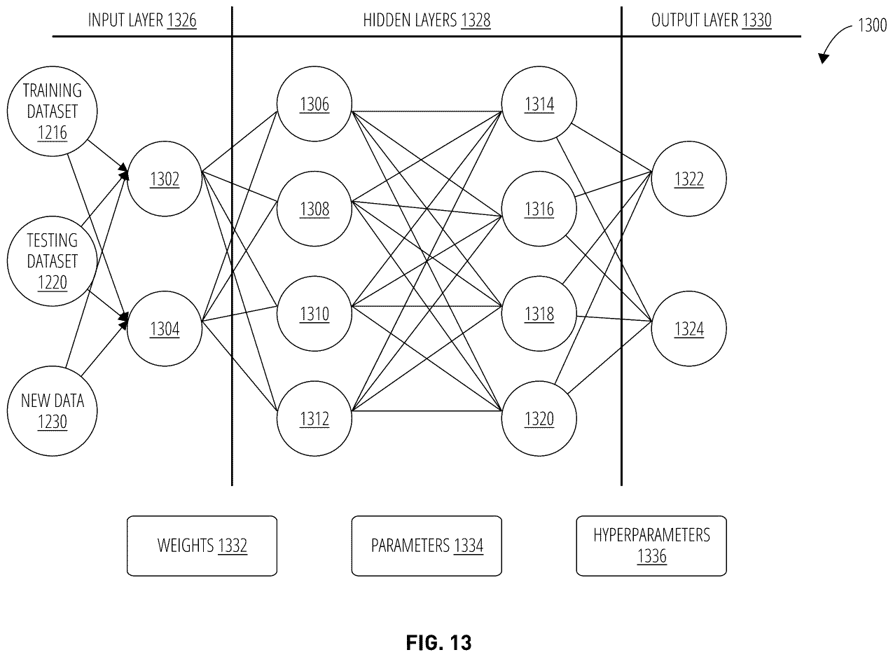

As previously described with reference to FIGS. 1, 2, the connection network system 100 and/or the apparatus 900 may implement some or all of the logic diagram 1200 to support various use cases and solutions for various AI/ML tasks. In various embodiments, the training device 902 of the apparatus 900 uses the logic diagram 1200 to generate and train the ML model 230 for use by the connection network platform 112 for the client application 110. In one embodiment, for example, the training device 902 may train the ML model 920 as a neural network, as described in more detail with reference to FIG. 13. Other use cases and solutions for AI/ML are possible as well, and embodiments are not limited in this context.

FIG. 13 illustrates an embodiment of an artificial neural network 1300. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1300 comprises multiple node layers, containing an input layer 1326, one or more hidden layers 1328, and an output layer 1330. Each layer comprises one or more nodes, such as nodes 1302 to 1324. As depicted in FIG. 13, for example, the input layer 1326 has nodes 1302, 1304. The artificial neural network 1300 has two hidden layers 1328, with a first hidden layer having nodes 1306, 1308, 1310 and 1312, and a second hidden layer having nodes 1314, 1316, 1318 and 1320. The artificial neural network 1300 has an output layer 1330 with nodes 1322, 1324. Each node 1302 to 1324 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1300 relies on training dataset 1216 to learn and improve accuracy over time. However, once the artificial neural network 1300 is fine-tuned for accuracy, and tested on testing dataset 1220, the artificial neural network 1300 is ready to classify and cluster new data 1230 at a high velocity. Tasks in speech recognition or image recognition can take minutes versus hours when compared to the manual identification by human experts.

Once an input layer 1326 is determined, a set of weights 1332 are assigned. The weights 1332 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1300 as a feedforward network.

In one embodiment, the artificial neural network 1300 leverages sigmoid neurons, which are distinguished by having values between 0 and 1. Since the artificial neural network 1300 behaves similarly to a decision tree, cascading data from one node to another, having x values between 0 and 1 will reduce the impact of any given change of a single variable on the output of any given node, and subsequently, the output of the artificial neural network 1300.

The artificial neural network 1300 has many practical use cases, like image recognition, speech recognition, text recognition or classification. The artificial neural network 1300 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = M S E = \frac{1}{2 m} {\sum }_{i = 1}^{m} {( {\hat{y}}_{i} - {y}_{i} )}^{2} \to MIN \qquad EQUATION ( 2 )$$

In Equation (3), i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1334 of the model adjust to gradually converge at the minimum.

In one embodiment, the artificial neural network 1300 is feedforward, meaning it flows in one direction only, from input to output. In one embodiment, the artificial neural network 1300 uses backpropagation. Backpropagation is when the artificial neural network 1300 moves in the opposite direction from output to input. Backpropagation allows calculation and attribution of errors associated with each neuron 1302 to 1324, thereby allowing adjustment to fit the parameters 1334 of the ML model 230 appropriately.

The artificial neural network 1300 is implemented as different neural networks depending on a given task. Neural networks are classified into different types, which are used for different purposes. In one embodiment, the artificial neural network 1300 is implemented as a feedforward neural network, or multi-layer perceptrons (MLPs), comprised of an input layer 1326, hidden layers 1328, and an output layer 1330. While these neural networks are also commonly referred to as MLPs, they are actually comprised of sigmoid neurons, not perceptrons, as most real-world problems are nonlinear. Trained data 1204 usually is fed into these models to train them, and they are the foundation for computer vision, natural language processing, and other neural networks. In one embodiment, the artificial neural network 1300 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1300 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1300 is implemented as any type of neural network suitable for a given operational task of system 200, and the MLP, CNN, and RNN are merely a few examples. Embodiments are not limited in this context.

The artificial neural network 1300 includes a set of associated parameters 1334. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1300 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1336. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

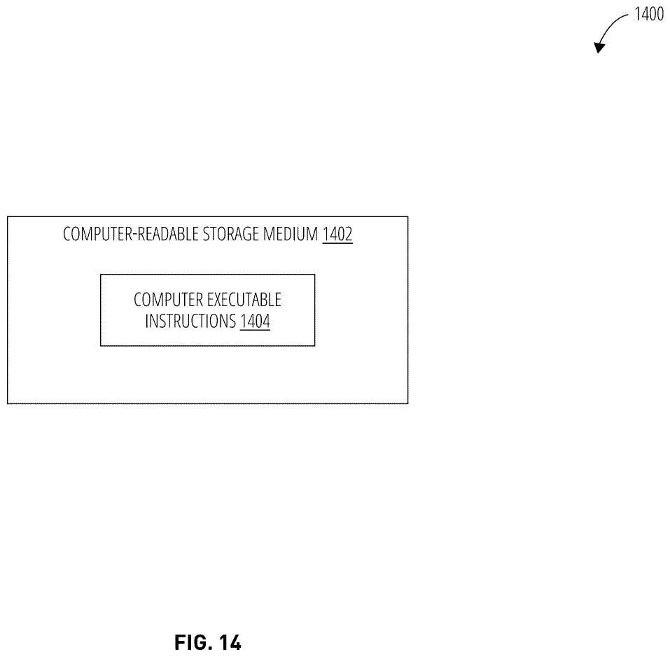

FIG. 14 illustrates an apparatus 1400. Apparatus 1400 comprises any non-transitory computer-readable storage medium 1402 or machine-readable storage medium, such as an optical, magnetic or semiconductor storage medium. In various embodiments, apparatus 1400 comprises an article of manufacture or a product. In some embodiments, the computer-readable storage medium 1402 stores computer executable instructions with which one or more processing devices or processing circuitry can execute. For example, computer executable instructions 1404 includes instructions to implement operations described with respect to any logic flows described herein. Examples of computer-readable storage medium 1402 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1404 include any suitable type of code, such as source code, compiled code, interpreted code, executable code, static code, dynamic code, object-oriented code, visual code, and the like.

FIG. 15 illustrates an embodiment of a computing architecture 1500. Computing architecture 1500 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1500 has a single processor with one core or more than one processor. Note that the term “processor” refers to a processor with a single core or a processor package with multiple processor cores. In at least one embodiment, the computing architecture 1500 is representative of the components of the system 200. More generally, the computing architecture 1500 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1500. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 15, computing architecture 1500 comprises a system-on-chip (SoC) 1502 for mounting platform components. System-on-chip (SoC) 1502 is a point-to-point (P2P) interconnect platform that includes a first processor 1504 and a second processor 1506 coupled via a point-to-point interconnect 1570 such as an Ultra Path Interconnect (UPI). In other embodiments, the computing architecture 1500 is another bus architecture, such as a multi-drop bus. Furthermore, each of processor 1504 and processor 1506 are processor packages with multiple processor cores including core(s) 1508 and core(s) 1510, respectively. While the computing architecture 1500 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1504 and chipset 1532. Some platforms include additional components and some platforms include sockets to mount the processors and/or the chipset. Furthermore, some platforms do not have sockets (e.g. SoC, or the like). Although depicted as a SoC 1502, one or more of the components of the SoC 1502 are included in a single die package, a multi-chip module (MCM), a multi-die package, a chiplet, a bridge, and/or an interposer. Therefore, embodiments are not limited to a SoC.

The processor 1504 and processor 1506 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1504 and/or processor 1506. Additionally, the processor 1504 need not be identical to processor 1506.

Processor 1504 includes an integrated memory controller (IMC) 1520 and point-to-point (P2P) interface 1524 and P2P interface 1528. Similarly, the processor 1506 includes an IMC 1522 as well as P2P interface 1526 and P2P interface 1530. IMC 1520 and IMC 1522 couple the processor 1504 and processor 1506, respectively, to respective memories (e.g., memory 1516 and memory 1518). Memory 1516 and memory 1518 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1516 and the memory 1518 locally attach to the respective processors (i.e., processor 1504 and processor 1506). In other embodiments, the main memory couple with the processors via a bus and shared memory hub. Processor 1504 includes registers 1512 and processor 1506 includes registers 1514.

Computing architecture 1500 includes chipset 1532 coupled to processor 1504 and processor 1506. Furthermore, chipset 1532 are coupled to storage device 1550, for example, via an interface (I/F) 1538. The I/F 1538 may be, for example, a Peripheral Component Interconnect-enhanced (PCIe) interface, a Compute Express Link® (CXL) interface, or a Universal Chiplet Interconnect Express (UCIe) interface. Storage device 1550 stores instructions executable by circuitry of computing architecture 1500 (e.g., processor 1504, processor 1506, GPU 1548, accelerator 1554, vision processing unit 1556, or the like). For example, storage device 1550 can store instructions for the client device 202, the client device 206, the inferencing device 204, the training device 902, or the like.

Processor 1504 couples to the chipset 1532 via P2P interface 1528 and P2P 1534 while processor 1506 couples to the chipset 1532 via P2P interface 1530 and P2P 1536. Direct media interface (DMI) 1576 and DMI 1578 couple the P2P interface 1528 and the P2P 1534 and the P2P interface 1530 and P2P 1536, respectively. DMI 1576 and DMI 1578 is a high-speed interconnect that facilitates, e.g., eight Giga Transfers per second (GT/s) such as DMI 3.0. In other embodiments, the processor 1504 and processor 1506 interconnect via a bus.

The chipset 1532 comprises a controller hub such as a platform controller hub (PCH). The chipset 1532 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1532 comprises more than one controller hub such as a chipset with a memory controller hub, a graphics controller hub, and an input/output (I/O) controller hub.

In the depicted example, chipset 1532 couples with a trusted platform module (TPM) 1544 and UEFI, BIOS, FLASH circuitry 1546 via I/F 1542. The TPM 1544 is a dedicated microcontroller designed to secure hardware by integrating cryptographic keys into devices. The UEFI, BIOS, FLASH circuitry 1546 may provide pre-boot code. The I/F 1542 may also be coupled to a network interface circuit (NIC) 1580 for connections off-chip.

Furthermore, chipset 1532 includes the I/F 1538 to couple chipset 1532 with a high-performance graphics engine, such as, graphics processing circuitry or a graphics processing unit (GPU) 1548. In other embodiments, the computing architecture 1500 includes a flexible display interface (FDI) (not shown) between the processor 1504 and/or the processor 1506 and the chipset 1532. The FDI interconnects a graphics processor core in one or more of processor 1504 and/or processor 1506 with the chipset 1532.

The computing architecture 1500 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1554 and/or vision processing unit 1556 are coupled to chipset 1532 via I/F 1538. The accelerator 1554 is representative of any type of accelerator device (e.g., a data streaming accelerator, cryptographic accelerator, cryptographic co-processor, an offload engine, etc.). One example of an accelerator 1554 is the Intel® Data Streaming Accelerator (DSA). The accelerator 1554 is a device including circuitry to accelerate copy operations, data encryption, hash value computation, data comparison operations (including comparison of data in memory 1516 and/or memory 1518), and/or data compression. Examples for the accelerator 1554 include a USB device, PCI device, PCIe device, CXL device, UCIe device, and/or an SPI device. The accelerator 1554 also includes circuitry arranged to execute machine learning (ML) related operations (e.g., training, inference, etc.) for ML models. Generally, the accelerator 1554 is specially designed to perform computationally intensive operations, such as hash value computations, comparison operations, cryptographic operations, and/or compression operations, in a manner that is more efficient than when performed by the processor 1504 or processor 1506. Because the load of the computing architecture 1500 includes hash value computations, comparison operations, cryptographic operations, and/or compression operations, the accelerator 1554 greatly increases performance of the computing architecture 1500 for these operations.

The accelerator 1554 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1554. For example, the accelerator 1554 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1554 via a non-posted write (e.g., a deferred memory write (DMWr)). One example of an instruction that atomically submits a work descriptor to the shared work queue of the accelerator 1554 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1554. The dedicated work queue may accept job submissions via commands such as the movdir64b instruction.

Various I/O devices 1560 and display 1552 couple to the bus 1572, along with a bus bridge 1558 which couples the bus 1572 to a second bus 1574 and an I/F 1540 that connects the bus 1572 with the chipset 1532. In one embodiment, the second bus 1574 is a low pin count (LPC) bus. Various input/output (I/O) devices couple to the second bus 1574 including, for example, a keyboard 1562, a mouse 1564 and communication devices 1566.

Furthermore, an audio I/O 1568 couples to second bus 1574. Many of the I/O devices 1560 and communication devices 1566 reside on the system-on-chip (SoC) 1502 while the keyboard 1562 and the mouse 1564 are add-on peripherals. In other embodiments, some or all the I/O devices 1560 and communication devices 1566 are add-on peripherals and do not reside on the system-on-chip (SoC) 1502.

FIG. 16 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600.

As shown in FIG. 16, the communications architecture 1600 includes one or more clients 1602 and servers 1604. The clients 1602 and the servers 1604 are operatively connected to one or more respective client data stores 1608 and server data stores 1610 that can be employed to store information local to the respective clients 1602 and servers 1604, such as cookies and/or associated contextual information.

The clients 1602 and the servers 1604 communicate information between each other using a communication framework 1606. The communication framework 1606 implements any well-known communications techniques and protocols. The communication framework 1606 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1606 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1602 and the servers 1604. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

What is claimed is:

1. A method, comprising:
receiving a first vector by an embedding layer of a decision transformer, the first vector comprising a set of entity trajectory features associated with an entity identifier of a connection network system;
generating a first entity trajectory embedding from the set of entity trajectory features by the embedding layer, the first entity trajectory embedding comprising a sequence of values representing a first state, a first action, and a first reward associated with a first timestep;
generating a predicted action embedding based on the first entity trajectory embedding by the decision transformer, the predicted action embedding comprising values representing a predicted action to achieve a total reward given the first state, the first action, and the first reward;
selecting a target content item from a set of content items based on the predicted action embedding; and
causing a presentation of the target content item on a user interface of an electronic device.

2. The method of claim 1, wherein the first state comprises a content item from the set of content items, the first action comprises an impression or a click of the content item, and the first reward comprises a reward tuple of clicks, impressions, and rewards associated with the entity identifier and a content delivery campaign.

3. The method of claim 1, comprising:
receiving a signal of an action from a user interface element of the user interface in response to the presentation of the target content item on the user interface of the electronic device associated with the entity identifier;
storing the target content item as a second state associated with the entity identifier;
storing the action as a second action for the target content item associated with the entity identifier;
calculating a second reward based on the second state and the second action; and
generating a second entity trajectory embedding associated with the entity identifier by the embedding layer, the second entity trajectory embedding comprising a sequence of values representing the second state, the second action, and the second reward associated with a second timestep.

4. The method of claim 1, comprising:
receiving the predicted action embedding from the decision transformer as a first input to a matching layer of a multi-tower machine learning (ML) model;
receiving a user embedding from a first tower of the multi-tower ML model as a second input to the matching layer, the user embedding comprising values representing user data and activity data associated with the entity identifier;
receiving a campaign embedding from a second tower of the multi-tower ML model as a third input to the matching layer, the campaign embedding comprising values representing campaign data for the content delivery campaign; and
generating a metric based on the predicted action embedding, the user embedding, and the campaign embedding by the matching layer.

5. The method of claim 4, comprising:
matching the predicted action embedding, the user embedding and the campaign embedding using a similarity measure to form a matched embedding; and
generating the metric based on the matched embedding.

6. The method of claim 4, wherein the metric comprises a first value representing a probability of an interaction between the entity identifier and the target content item associated with the content delivery campaign.

7. The method of claim 4, wherein the metric comprises a second value representing a reward tuple of clicks, impressions, and rewards associated with the entity identifier and a content delivery campaign.

8. The method of claim 1, comprising:
collecting a training dataset comprising multiple training datapoints, wherein a training datapoint comprises entity trajectory embeddings associated with an entity identifier of the connection network system; and
training the decision transformer using the training dataset in an offline mode.

9. The method of claim 1, wherein the first state comprises a content item from the set of content items, the content item comprising an electronic image, an animation, a video, or text information.

10. An apparatus, comprising:
circuitry;
memory operably coupled to the circuitry, the memory storing instructions that when executed by the circuitry causes the circuitry to:
receive a first vector by an embedding layer of a decision transformer, the first vector comprising a set of entity trajectory features associated with an entity identifier of a connection network system;
generate a first entity trajectory embedding from the set of entity trajectory features by the embedding layer, the first entity trajectory embedding comprising a sequence of values representing a first state, a first action, and a first reward associated with a first timestep;
generate a predicted action embedding based on the first entity trajectory embedding by the decision transformer, the predicted action embedding comprising values representing a predicted action to achieve a total reward given the first state, the first action, and the first reward;
select a target content item from a set of content items based on the predicted action embedding; and
cause a presentation of the target content item on a user interface of an electronic device.

11. The apparatus of claim 10, wherein the first state comprises a content item from the set of content items, the first action comprises an impression or a click of the content item, and the first reward comprises a reward tuple of clicks, impressions, and rewards associated with the entity identifier and a content delivery campaign.

12. The apparatus of claim 10, the circuitry to:
receive a signal of an action from a user interface element of the user interface in response to the presentation of the target content item on the user interface of the electronic device associated with the entity identifier;
store the target content item as a second state associated with the entity identifier;
store the action as a second action for the target content item associated with the entity identifier;
calculate a second reward based on the second state and the second action; and
generate a second entity trajectory embedding associated with the entity identifier by the embedding layer, the second entity trajectory embedding comprising a sequence of values representing the second state, the second action, and the second reward associated with a second timestep.

13. The apparatus of claim 10, the circuitry to:
receive the predicted action embedding from the decision transformer as a first input to a matching layer of a multi-tower machine learning (ML) model;
receive a user embedding from a first tower of the multi-tower ML model as a second input to the matching layer, the user embedding comprising values representing user data and activity data associated with the entity identifier;
receive a campaign embedding from a second tower of the multi-tower ML model as a third input to the matching layer, the campaign embedding comprising values representing campaign data for the content delivery campaign; and
generate a metric based on the predicted action embedding, the user embedding, and the campaign embedding by the matching layer.

14. The apparatus of claim 13, the circuitry to:
collect a training dataset comprising multiple training datapoints, wherein a training datapoint comprises entity trajectory embeddings associated with an entity identifier of the connection network system; and
train the decision transformer using the training dataset in an offline mode.

15. The method of claim 13, wherein the metric comprises a first value representing a probability of an interaction between the entity identifier and the target content item associated with the content delivery campaign, or the metric comprises a second value representing a reward tuple of clicks, impressions, and rewards associated with the entity identifier and a content delivery campaign.

16. A non-transitory machine-readable medium comprising instructions that when executed by circuitry causes the circuitry to:
receive a first vector by an embedding layer of a decision transformer, the first vector comprising a set of entity trajectory features associated with an entity identifier of a connection network system;
generate a first entity trajectory embedding from the set of entity trajectory features by the embedding layer, the first entity trajectory embedding comprising a sequence of values representing a first state, a first action, and a first reward associated with a first timestep;
generate a predicted action embedding based on the first entity trajectory embedding by the decision transformer, the predicted action embedding comprising values representing a predicted action to achieve a total reward given the first state, the first action, and the first reward;
select a target content item from a set of content items based on the predicted action embedding; and
cause a presentation of the target content item on a user interface of an electronic device.

17. The machine-readable medium of claim 16, wherein the first state comprises a content item from the set of content items, the first action comprises an impression or a click of the content item, and the first reward comprises a reward tuple of clicks, impressions, and rewards associated with the entity identifier and a content delivery campaign.

18. The machine-readable medium of claim 16, comprising instructions that when executed by circuitry causes the circuitry to:
receive a signal of an action from a user interface element of the user interface in response to the presentation of the target content item on the user interface of the electronic device associated with the entity identifier;
store the target content item as a second state associated with the entity identifier;
store the action as a second action for the target content item associated with the entity identifier;
calculate a second reward based on the second state and the second action; and
generate a second entity trajectory embedding associated with the entity identifier by the embedding layer, the second entity trajectory embedding comprising a sequence of values representing the second state, the second action, and the second reward associated with a second timestep.

19. The machine-readable medium of claim 16, comprising instructions that when executed by circuitry causes the circuitry to:
receive the predicted action embedding from the decision transformer as a first input to a matching layer of a multi-tower machine learning (ML) model;
receive a user embedding from a first tower of the multi-tower ML model as a second input to the matching layer, the user embedding comprising values representing user data and activity data associated with the entity identifier;
receive a campaign embedding from a second tower of the multi-tower ML model as a third input to the matching layer, the campaign embedding comprising values representing campaign data for the content delivery campaign; and
generate a metric based on the predicted action embedding, the user embedding, and the campaign embedding by the matching layer.

20. The method of claim 19, wherein the metric comprises a first value representing a probability of an interaction between the entity identifier and the target content item associated with the content delivery campaign, or the metric comprises a second value representing a reward tuple of clicks, impressions, and rewards associated with the entity identifier and a content delivery campaign.
